(19) United States
(12) Patent Application Publication
(10) Pub. No.: US 2025/0244956 A1
(43) Pub. Date: Jul. 31, 2025

(54) BULK CONFIGURATION OF NEW DEVICES AND TOPOLOGY MANAGEMENT

(71) Applicant: Rockwell Automation Technologies, Inc., Mayfield Heights, OH (US)

(72) Inventors: Michael Wilson, Milwaukee, WI (US); Michael Miller, Waterford, WI (US); Daniel T. Richter, Hudson, OH (US); Maria Echavarria Restrepo, Medellin (CO); Kurt E. Mathson, Menomonee Falls, WI (US); Nicholas Joseph DiDona, Chagrin Falls, OH (US); Justin M. Lemminger, New Berlin, WI (US); Ashish Anand, Aurora, OH (US)

(21) Appl. No.: 18/974,315

(22) Filed: Dec. 9, 2024

Related U.S. Application Data
(60) Provisional application No. 63/626,108, filed on Jan. 29, 2024.

(51) Int. Cl. G06F 8/20

(52) U.S. Cl. CPC G06F 8/20

(57) ABSTRACT

An industrial integrated development environment (IDE) system includes device definition creation tools that can be used to select, configure, and add multiple device definitions to a control project using a single workflow. A device selection interface can be used to select multiple device definitions to be added to the project, and a device configuration interface can be used to set values of each device's configuration parameters. Upon completion of this device selection and configuration workflow, all selected device definitions and their associated configuration parameter values are added to the control project substantially simultaneously. The workflow allows the user to initially identify a parent device, backplane, or network to which the new devices will be assigned, or to add the new devices as unassigned devices and assign the new devices to a selected parent device, backplane, or network after creation.

### CROSS-REFERENCE TO RELATED APPLICATIONS

This application claims priority to U.S. Provisional Patent Application Ser. No. 63/626,108, filed on Jan. 29, 2024, and entitled “BULK CONFIGURATION OF NEW DEVICES AND TOPOLOGY MANAGEMENT,” the entirety of which is incorporated herein by reference.

### TECHNICAL FIELD

The subject matter disclosed herein relates generally to industrial automation systems, and, for example, to industrial programming development platforms

### BACKGROUND ART

The various control, monitoring, and analytical devices that make up an industrial automation system must be programmed or configured using configuration applications specific to each device. For example, industrial controllers are typically configured and programmed using a control programming development application such as an industrial integrated development environment (IDE) system. Such IDE systems are also used to configure device parameters of various industrial devices that make up the automation system.

### BRIEF DESCRIPTION

The following presents a simplified summary in order to provide a basic understanding of some aspects described herein. This summary is not an extensive overview nor is intended to identify key/critical elements or to delineate the scope of the various aspects described herein. Its sole purpose is to present some concepts in a simplified form as a prelude to the more detailed description that is presented later.

In one or more embodiments, a system is provided, comprising a user interface component configured to render an integrated development environment (IDE) interface and to receive, via interaction with the IDE interface, design input that defines aspects of an industrial automation control project; a project generation component configured to generate system project data based on the design input, the system project data comprising at least one of an executable industrial control program or device configuration data, wherein the user interface component configured to: render a device selection interface that displays a list of available device definitions and that is configured to receive, as part of the design input, selection input that selects multiple device definitions of the available device definitions; and render a device configuration interface that displays, on a common interface, a list of the multiple device definitions and device configuration controls for the multiple device definitions, and that is configured to receive, as part of the design input via interaction with the device configuration controls, device configuration input that sets values of device configuration parameters for the multiple device definitions, and the project generation component is configured to, in response to selection of a control, add the multiple device definitions and the values of the device configuration parameters to the industrial control project based on the selection input and the device configuration input.

Also, one or more embodiments provide a method, comprising rendering, by a system comprising a processor, an integrated development environment (IDE) interface on a client device; receiving, by the system via interaction with the IDE interface, design input that defines aspects of an industrial automation control project, wherein the receiving comprises: rendering, in response to an interaction with the IDE interface, a device selection interface that displays a list of available device definitions; receiving, as part of the design input, selection input that selects multiple device definitions of the available device definitions; rendering a device configuration interface that displays, on a common interface, a list of the multiple device definitions and device configuration controls for the multiple device definitions; and receiving, as part of the design input via interaction with the device configuration controls, device configuration input that sets values of device configuration parameters for the multiple device definitions; in response to selection of a control, adding, by the system, the multiple device definitions and the values of the device configuration parameters to the industrial control project based on the selection input and the device configuration input; and generating, by the system, system project data based on the design input, the system project data comprising at least one of an executable industrial control program or device configuration data.

Also, according to one or more embodiments, a non-transitory computer-readable medium is provided having stored thereon instructions that, in response to execution, cause an industrial IDE system to perform operations, the operations comprising: rendering an integrated development environment (IDE) interface on a client device; receiving, via interaction with the IDE interface, design input that defines aspects of an industrial automation control project, wherein the receiving comprises: rendering, in response to an interaction with the IDE interface, a device selection interface that displays a list of available device definitions; receiving, as part of the design input, selection input that selects multiple device definitions of the available device definitions; rendering a device configuration interface that displays, on a common interface, a list of the multiple device definitions and device configuration controls for the multiple device definitions; and receiving, as part of the design input via interaction with the device configuration controls, device configuration input that sets values of device configuration parameters for the multiple device definitions; in response to selection of a control, adding the multiple device definitions and the values of the device configuration parameters to the industrial control project based on the selection input and the device configuration input; and generating system project data based on the design input, the system project data comprising at least one of an executable industrial control program or device configuration data.

To the accomplishment of the foregoing and related ends, certain illustrative aspects are described herein in connection with the following description and the annexed drawings. These aspects are indicative of various ways which can be practiced, all of which are intended to be covered herein. Other advantages and novel features may become apparent from the following detailed description when considered in conjunction with the drawings.

### BRIEF DESCRIPTION OF THE DRAWINGS

FIG. 1 is a block diagram of an example industrial control environment.

FIG. 2 is a block diagram of an example integrated development environment (IDE) system.

FIG. 3 is a diagram illustrating example data flows associated with creation of a system project for an automation system being designed using IDE system.

FIG. 4 is a diagram illustrating commissioning of a system project.

FIG. 5 is a diagram illustrating configuration of device parameters using device profiles.

FIG. 6 is an example development interface that can be rendered on a client device by the industrial IDE system.

FIG. 7 is a view of the explorer panel and its associated navigation tree in isolation.

FIG. 8 is a view of the main workspace area in which a Device Information editing window has been invoked for a selected device.

FIG. 9a is a view of a main workspace area of an IDE development platform in which the user has selected a 16-point digital input module.

FIG. 9b is a view of the main workspace area in which a Configuration category has been selected in the Category window.

FIG. 9c is a view of the main workspace area in which a Points category has been selected in the Category window.

FIG. 10a is a view of the main workspace area in which an 8-channel analog input module has been selected.

FIG. 10b is a view of the main workspace area in which configuration parameters for a first channel of the 8-channel analog input module are being set.

FIG. 10c is a view of the main workspace area in which configuration parameters for a second channel of the 8-channel analog input module are being set.

FIG. 11 is a view of another example device configuration interface illustrating a workflow for adding a configured device to a control project.

FIG. 12 is a view of an explorer panel illustrating an example user interaction for initiating the process of adding devices to a control system project.

FIG. 13 is an example Device Selection interface that can be rendered by the IDE system.

FIG. 14 is a view of the Device Selection interface in which a user has selecting two devices from the Device Selection window.

FIG. 15 is an example Device Configuration interface that can be rendered by the IDE system.

FIG. 16 is a view of the explorer panel illustrating the updated project navigation tree after the three devices have been added to the control system project.

FIG. 17 is another view of the Device Configuration interface illustrating configuration of an ethernet bridge device.

FIG. 18 is a view of the explorer panel illustrating the updated project navigation tree after the ethernet bridge device has been added to the project.

FIG. 19 is a view of the explorer panel illustrating the initiation of a workflow for adding a new device without initially assigning the new device to another device, backplane, or network.

FIG. 20 is a view of the Device Selection interface depicting a scenario in which the user has selected seven new devices to be added to the project.

FIG. 21 is a view of the Device Configuration interface as the seven new devices are being configured.

FIG. 22 is a view of the explorer panel depicting the updated project navigation tree after seven new devices have been added to the project.

FIG. 23 is a view of the explorer panel in which the user has selected a device from the navigation tree to which one or more of unassigned devices will be added.

FIG. 24 is a view of the Device Selection interface in which the user has selected multiple unassigned devices that are to be assigned to a selected backplane.

FIG. 25 is a view of the explorer panel after the user has selected the Continue button of the Device Selection interface.

FIG. 26a is a flowchart of a first part of an example methodology for adding and configuring multiple device definitions to an industrial automation or control project in bulk.

FIG. 26b is a flowchart of a second part of the example methodology for adding and configuring multiple device definitions to an industrial automation or control project in bulk.

FIG. 27 is an example computing environment.

FIG. 28 is an example networking environment.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding thereof. It may be evident, however, that the subject disclosure can be practiced without these specific details. In other instances, well-known structures and devices are shown in block diagram form in order to facilitate a description thereof.

As used in this application, the terms “component,” “system,” “platform,” “layer,” “controller,” “terminal,” “station,” “node,” “interface” are intended to refer to a computer-related entity or an entity related to, or that is part of, an operational apparatus with one or more specific functionalities, wherein such entities can be either hardware, a combination of hardware and software, software, or software in execution. For example, a component can be, but is not limited to being, a process running on a processor, a processor, a hard disk drive, multiple storage drives (of optical or magnetic storage medium) including affixed (e.g., screwed or bolted) or removable affixed solid-state storage drives; an object; an executable; a thread of execution; a computer-executable program, and/or a computer. By way of illustration, both an application running on a server and the server can be a component. One or more components can reside within a process and/or thread of execution, and a component can be localized on one computer and/or distributed between two or more computers. Also, components as described herein can execute from various computer readable storage media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry which is operated by a software or a firmware application executed by a processor, wherein the processor can be internal or external to the apparatus and executes at least a part of the software or firmware application. As yet another example, a component can be an apparatus that provides specific functionality through electronic components without mechanical parts, the electronic components can include a processor therein to execute software or firmware that provides at least in part the functionality of the electronic components. As further yet another example, interface(s) can include input/output (I/O) components as well as associated processor, application, or Application Programming Interface (API) components. While the foregoing examples are directed to aspects of a component, the exemplified aspects or features also apply to a system, platform, interface, layer, controller, terminal, and the like.

As used herein, the terms “to infer” and “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

In addition, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Furthermore, the term “set” as employed herein excludes the empty set; e.g., the set with no elements therein. Thus, a “set” in the subject disclosure includes one or more elements or entities. As an illustration, a set of controllers includes one or more controllers; a set of data resources includes one or more data resources; etc. Likewise, the term “group” as utilized herein refers to a collection of one or more entities; e.g., a group of nodes refers to one or more nodes.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches also can be used.

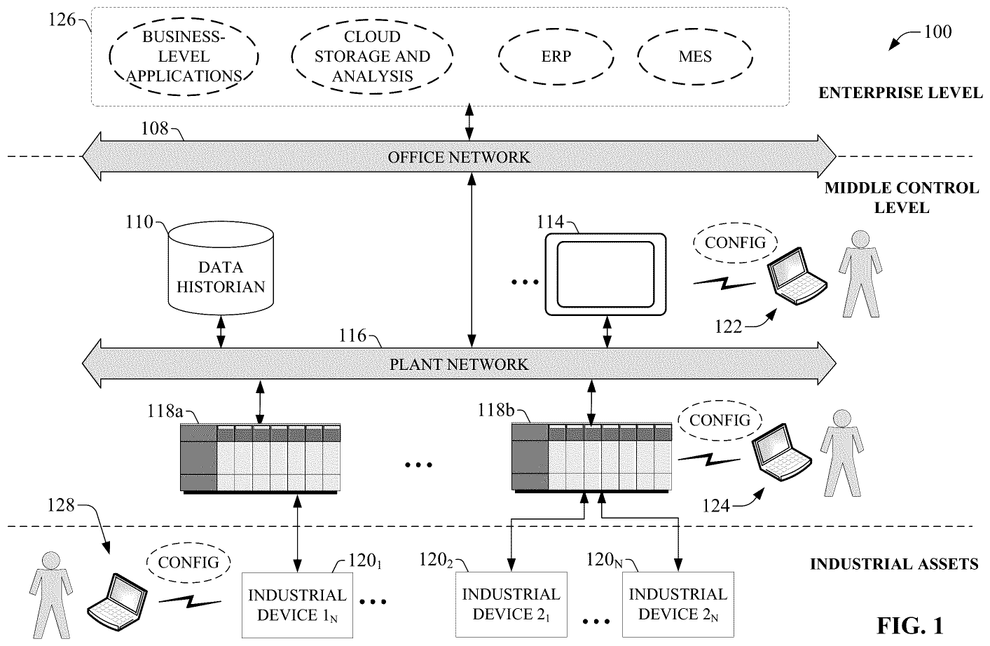

FIG. 1 is a block diagram of an example industrial control environment 100. In this example, a number of industrial controllers 118 are deployed throughout an industrial plant environment to monitor and control respective industrial systems or processes relating to product manufacture, machining, motion control, batch processing, material handling, or other such industrial functions. Industrial controllers 118 typically execute respective control programs to facilitate monitoring and control of industrial devices 120 making up the controlled industrial assets or systems (e.g., industrial machines). One or more industrial controllers 118 may also comprise a soft controller executed on a personal computer or other hardware platform, or on a cloud platform. Some hybrid devices may also combine controller functionality with other functions (e.g., visualization). The control programs executed by industrial controllers 118 can comprise substantially any type of code capable of processing input signals read from the industrial devices 120 and controlling output signals generated by the industrial controllers 118, including but not limited to ladder logic, sequential function charts, function block diagrams, or structured text.

Industrial devices 120 may include both input devices that provide data relating to the controlled industrial systems to the industrial controllers 118, and output devices that respond to control signals generated by the industrial controllers 118 to control aspects of the industrial systems. Example input devices can include telemetry devices (e.g., temperature sensors, flow meters, level sensors, pressure sensors, etc.), manual operator control devices (e.g., push buttons, selector switches, etc.), safety monitoring devices (e.g., safety mats, safety pull cords, light curtains, etc.), and other such devices. Output devices may include motor drives, pneumatic actuators, signaling devices, robot control inputs, valves, pumps, and the like.

Industrial controllers 118 may communicatively interface with industrial devices 120 over hardwired or networked connections. For example, industrial controllers 118 can be equipped with native hardwired inputs and outputs that communicate with the industrial devices 120 to effect control of the devices. The native controller I/O can include digital I/O that transmits and receives discrete voltage signals to and from the field devices, or analog I/O that transmits and receives analog voltage or current signals to and from the devices. The controller I/O can communicate with a controller's processor over a backplane such that the digital and analog signals can be read into and controlled by the control programs. Industrial controllers 118 can also communicate with industrial devices 120 over a network using, for example, a communication module or an integrated networking port. Exemplary networks can include the Internet, intranets, Ethernet, DeviceNet, ControlNet, Data Highway and Data Highway Plus (DH/DH+), Remote I/O, Fieldbus, Modbus, Profibus, wireless networks, serial protocols, and the like. The industrial controllers 118 can also store persisted data values that can be referenced by their associated control programs and used for control decisions, including but not limited to measured or calculated values representing operational states of a controlled machine or process (e.g., tank levels, positions, alarms, etc.) or captured time series data that is collected during operation of the automation system (e.g., status information for multiple points in time, diagnostic occurrences, etc.). Similarly, some intelligent devices—including but not limited to motor drives, instruments, or condition monitoring modules—may store data values that are used for control and/or to visualize states of operation. Such devices may also capture time-series data or events on a log for later retrieval and viewing.

Industrial automation systems often include one or more human-machine interfaces (HMIs) 114 that allow plant personnel to view telemetry and status data associated with the automation systems, and to control some aspects of system operation. HMIs 114 may communicate with one or more of the industrial controllers 118 over a plant network 116, and exchange data with the industrial controllers to facilitate visualization of information relating to the controlled industrial processes on one or more pre-developed operator interface screens. HMIs 114 can also be configured to allow operators to submit data to specified data tags or memory addresses of the industrial controllers 118, thereby providing a means for operators to issue commands to the controlled systems (e.g., cycle start commands, device actuation commands, etc.), to modify setpoint values, etc. HMIs 114 can generate one or more display screens through which the operator interacts with the industrial controllers 118, and thereby with the controlled processes and/or systems. Example display screens can visualize present states of industrial systems or their associated devices using graphical representations of the processes that display metered or calculated values, employ color or position animations based on state, render alarm notifications, or employ other such techniques for presenting relevant data to the operator. Data presented in this manner is read from industrial controllers 118 by HMIs 114 and presented on one or more of the display screens according to display formats chosen by the HMI developer. HMIs may comprise fixed location or mobile devices with either user-installed or pre-installed operating systems, and either user-installed or pre-installed graphical application software.

Some industrial environments may also include other systems or devices relating to specific aspects of the controlled industrial systems. These may include, for example, a data historian 110 that aggregates and stores production information collected from the industrial controllers 118 or other data sources, device documentation stores containing electronic documentation for the various industrial devices making up the controlled industrial systems, inventory tracking systems, work order management systems, repositories for machine or process drawings and documentation, vendor product documentation storage, vendor knowledgebases, internal knowledgebases, work scheduling applications, or other such systems, some or all of which may reside on an office network 108 of the industrial environment.

Higher-level systems 126 may carry out functions that are less directly related to control of the industrial automation systems on the plant floor, and instead are directed to long term planning, high-level supervisory control, analytics, reporting, or other such high-level functions. These systems 126 may reside on the office network 108 at an external location relative to the plant facility, or on a cloud platform with access to the office and/or plant networks. Higher-level systems 126 may include, but are not limited to, cloud storage and analysis systems, big data analysis systems, manufacturing execution systems, data lakes, reporting systems, etc. In some scenarios, applications running at these higher levels of the enterprise may be configured to analyze control system operational data, and the results of this analysis may be fed back to an operator at the control system or directly to a controller 118 or device 120 in the control system.

The various control, monitoring, and analytical devices that make up an industrial environment must be programmed or configured using respective configuration applications specific to each device. For example, industrial controllers 118 are typically configured and programmed using a control programming development application such as a ladder logic editor (e.g., executing on a client device 124). Using such development platforms, a designer can write control programming (e.g., ladder logic, structured text, function block diagrams, etc.) for carrying out a desired industrial sequence or process and download the resulting program files to the controller 118. Separately, developers design visualization screens and associated navigation structures for HMIs 114 using an HMI development platform (e.g., executing on client device 122) and download the resulting visualization files to the HMI 114. Some industrial devices 120—such as motor drives, telemetry devices, safety input devices, etc.—may also require configuration using separate device configuration tools (e.g., executing on client device 128) that are specific to the device being configured. Such device configuration tools may be used to set device parameters or operating modes (e.g., high/low limits, output signal formats, scale factors, energy consumption modes, etc.).

Some industrial development platforms support development workflows in which device definitions corresponding to physical devices used in the automation system (e.g., I/O modules, motor drives, etc.) can be added to the control software project and configured to reflect the desired device configurations of the physical devices. According to one approach for creating and adding device definitions to a control project, a developer can select a device profile corresponding to a desired device type from a library of such device profiles maintained by the IDE system, and configure the device definition by interacting with the selected profile's configuration interface. These device profile interfaces, which comprise navigation tabs, data fields, and selection controls for setting the device's various configuration parameters, typically have a complicated layout design that requires the user to perform many navigational and configuration steps in order to add and configure the device. Moreover, these device definition interfaces do not support the ability to add multiple instances of a given device to a project in bulk. Instead, each instance of a device must be added to a project individually, even if multiple similar devices are to be included in the control project. These laborious device configuration workflows, as well as the necessity to add devices to a project one at a time, can add considerable time to the control solution development time.

To address these or other issues, one or more embodiments described herein provide an integrated development environment (IDE) for designing, programming, and configuring an industrial automation system using a common design environment, in which the IDE system includes device definition creation tools that allow users to create and add device definitions to a control project using a single device selection and configuration workflow that can be used to create various types of devices within the project. A single device selection interface can be used to select multiple device type definitions to be added to the project (e.g., I/O modules or other types of controller modules), and a single device configuration interface can be used to set device configurations or parameter values for the selected device definitions. Upon completion of the device selection and configuration steps, all of the selected and configured device definitions are added to the project substantially simultaneously.

If the newly added devices are to be assigned to another device, backplane, or network already defined in the project, the device selection interface allows the user to identify the device to which the new devices will be assigned as part of the workflow, such that the new devices are assigned to the selected parent device upon creation. The workflow also permits the user to, alternatively, add the new devices as initially unassigned devices, which can be selectively assigned to other devices, backplanes, or networks after creation.

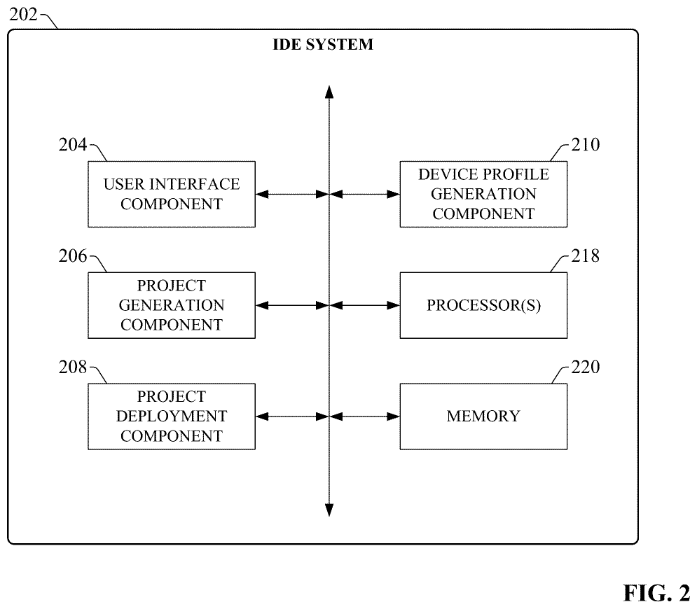

FIG. 2 is a block diagram of an example integrated development environment (IDE) system 202 according to one or more embodiments of this disclosure. Aspects of the systems, apparatuses, or processes explained in this disclosure can constitute machine-executable components embodied within machine(s), e.g., embodied in one or more computer-readable mediums (or media) associated with one or more machines. Such components, when executed by one or more machines, e.g., computer(s), computing device(s), automation device(s), virtual machine(s), etc., can cause the machine(s) to perform the operations described.

IDE system 202 can include a user interface component 204 including an IDE editor 224, a project generation component 206, a project deployment component 208, a device profile generation component 210, one or more processors 218, and memory 220. In various embodiments, one or more of the user interface component 204, project generation component 206, project deployment component 208, device profile generation component 210, the one or more processors 218, and memory 220 can be electrically and/or communicatively coupled to one another to perform one or more of the functions of the IDE system 202. In some embodiments, components 204, 206, 208, and 210, can comprise software instructions stored on memory 220 and executed by processor(s) 218. IDE system 202 may also interact with other hardware and/or software components not depicted in FIG. 2. For example, processor(s) 218 may interact with one or more external user interface devices, such as a keyboard, a mouse, a display monitor, a touchscreen, or other such interface devices.

User interface component 204 can be configured to receive user input and to render output to the user in any suitable format (e.g., visual, audio, tactile, etc.). In some embodiments, user interface component 204 can be configured to communicatively interface with an IDE client that executes on a client device (e.g., a laptop computer, tablet computer, smart phone, etc.) that is communicatively connected to the IDE system 202 (e.g., via a hardwired or wireless connection). The user interface component 204 can then receive user input data and render output data via the IDE client. In other embodiments, user interface component 314 can be configured to generate and serve suitable interface screens to a client device (e.g., program development screens), and exchange data via these interface screens. Input data that can be received via various embodiments of user interface component 204 can include, but is not limited to, programming code, industrial design specifications or goals, device definition and configuration data, device profile definition data, or other such input. Output data rendered by various embodiments of user interface component 204 can include program code, programming feedback (e.g., error and highlighting, coding suggestions, etc.), programming development screens, etc.

Project generation component 206 can be configured to create a system project comprising one or more project files based on design input received via the user interface component 204, as well as industrial knowledge, predefined code modules, and automation objects maintained by the IDE system 202. Project deployment component 208 can be configured to commission the system project created by the project generation component 206 to appropriate industrial devices (e.g., industrial controllers 118) for execution. To this end, project deployment component 208 can identify the appropriate target devices to which respective portions of the system project should be sent for execution, translate these respective portions to formats understandable by the target devices, and deploy the translated project components to their corresponding devices.

Device profile generation component 210 can be configured to generate a reusable device profile corresponding to a type of industrial device, asset, or system. The device profile can define configuration parameters for the corresponding industrial device, as defined by an authorized user of the IDE system 202. The device profile generation component 210 can generate the device profile based on profile definition data submitted by the user via a graphical profile definition interface rendered by the user interface component 204.

The one or more processors 218 can perform one or more of the functions described herein with reference to the systems and/or methods disclosed. Memory 220 can be a computer-readable storage medium storing computer-executable instructions and/or information for performing the functions described herein with reference to the systems and/or methods disclosed.

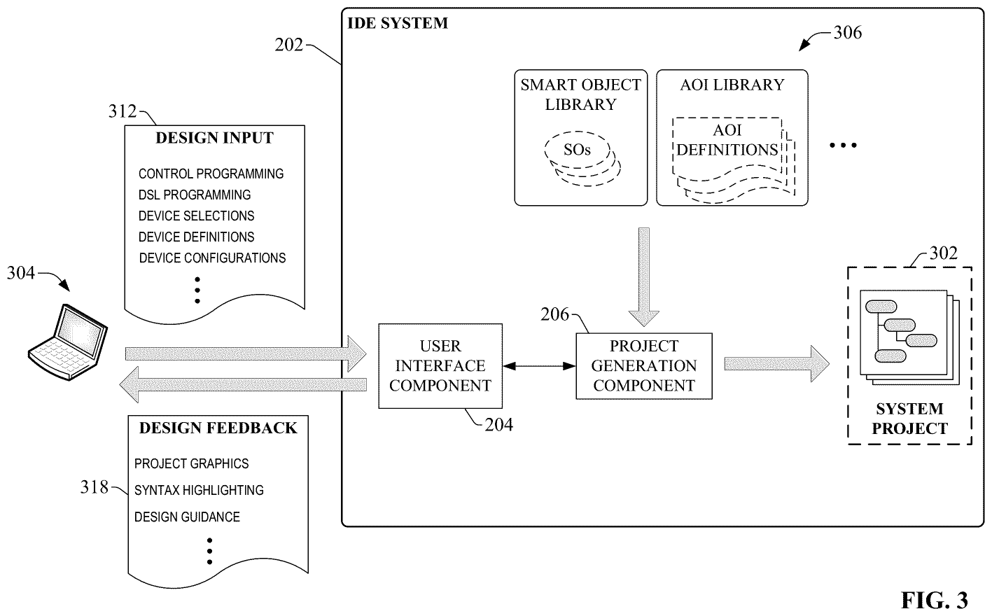

FIG. 3 is a diagram illustrating example data flows associated with creation of a system project 302 for an automation system being designed using IDE system 202 according to one or more embodiments. Some embodiments of the IDE system 202 can be implemented on a cloud platform and can support collaborative project development whereby multiple developers contribute design and programming input to a common automation system project 302. Collaborative tools supported by the IDE system 202 can manage design contributions from the multiple contributors and perform version control of the aggregate system project 302 to ensure project consistency.

A client device 304 (e.g., a laptop computer, tablet computer, desktop computer, mobile device, wearable AR/VR appliance, etc.) can access the IDE system's project development tools and leverage these tools to create a comprehensive system project 302 for an automation system being developed. Through interaction with the system's user interface component 204, developers can submit design input 312 to the IDE system 202 in various supported formats, including industry-specific control programming (e.g., control logic, structured text, sequential function charts, industrial domain-specific language (DSL), etc.). Based on this design input 312, user interface component 204 renders design feedback 318 designed to assist the developer in connection with developing a system project 302 for configuration and control of an industrial automation system. System project 302 can comprise one or more project files that encode control programming and device or sub-system configuration data (e.g., I/O module configurations, drive parameters, vision system configurations, telemetry device parameters, etc.).

The IDE system 202 maintains various libraries 306 or other information repositories which can be accessed by a developer in connection with generating control code or other aspects of a system project 302. These libraries 306 can include, but are not limited to, libraries of add-on instructions (AOIs) or other program instructions that that encode control or computational functionality and that can be added as elements to control routines, libraries of control code samples or smart objects that encapsulate reusable control code, libraries of user-defined data types (UDTs), libraries of product manuals for various types industrial devices or software platforms (including programming or instruction manuals for the IDE system's control code development platform, as well as vendor-specific device manuals), help files, vendor knowledgebases, training materials, industrial standards definitions, or other such libraries.

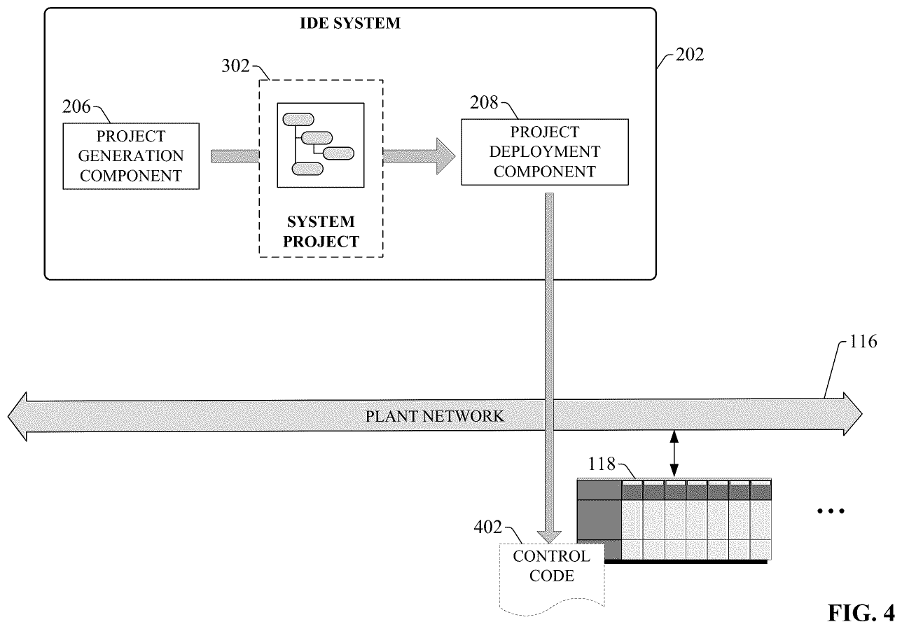

When a fully developed system project 302 for an automation system has been completed, the system project 302 can be deployed to one or more target control devices for execution. FIG. 4 is a diagram illustrating commissioning of a system project 302. Project deployment component 208 can compile or otherwise translate a completed system project 302 into one or more executable files or configuration files that can be stored and executed on respective target industrial devices of the automation system (e.g., industrial controllers 118, or other types of industrial devices such as motor drives, safety relays, etc.).

As noted above, system project 302 may comprise one or more of control code, device parameter definitions, or other such control project elements. Upon completion of project development, a user can identify which target device—e.g., an industrial controller 118—is to execute or receive the system project 302. Project deployment component 208 can then translate controller code defined by the system project 302 to a control program file 402 formatted for execution on the specified industrial controller 118 and send this control program file 402 to the controller 118 (e.g., via plant network 116) for execution. Execution of the control program file 402 on the controller 118 causes the controller 118 to perform monitoring and control functions for an industrial automation system in accordance with the control code and device configuration settings defined by the system project 302.

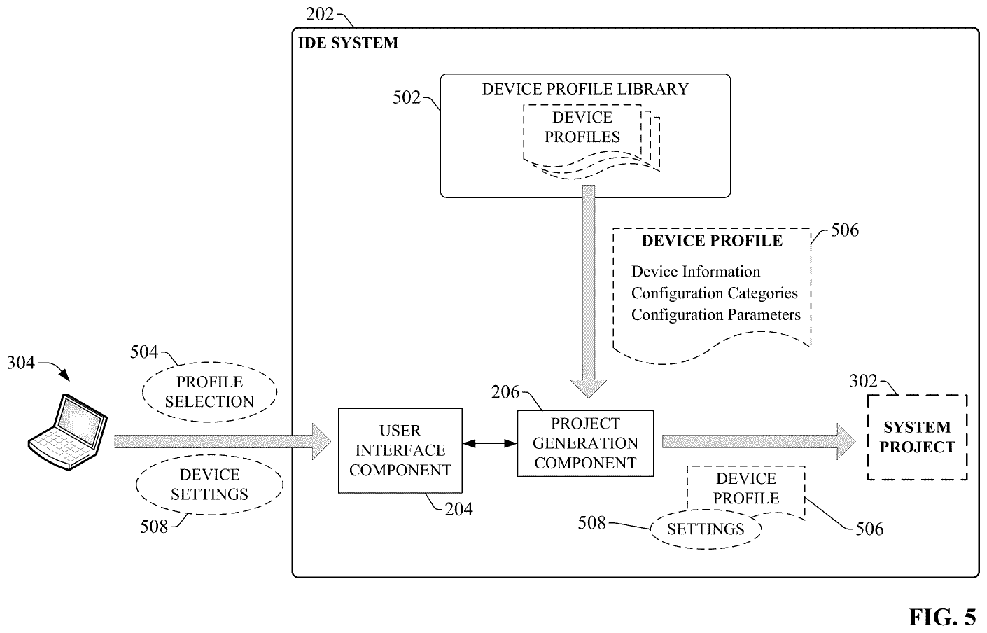

According to one approach to creating and adding device definitions to a control system project 302, some embodiments of the industrial IDE system 202 can support the use of device profiles to facilitate setting values of configurable device parameters for devices that are to be included in the automation project. FIG. 5 is a diagram illustrating configuration of device parameters using device profiles 506. In general, each device profile 506 corresponds to a device type, and is a re-usable object or file that defines a set of configurable device parameters—e.g., network or communication settings, scale factors, input or output signal types, operating mode settings, tuning parameter values, maximum or minimum values, refresh rates, channel configurations, etc.—for its corresponding device type. Each device profile 506 can organize these device configuration parameters into categories to assist the user in locating a desired parameter. The device profile 506 can also record general information about the device, some of which can be modified by the user to customize a generic device type to reflect a specific device (an instance of the device type).

In these embodiments, the IDE system 202 can store device profiles 506 for multiple types of devices in a device profile library 502 for selective inclusion in system projects 302. Device profiles 506 can be defined for a variety of different industrial devices or systems, including but not limited to industrial controller modules (e.g., analog or digital input and output modules, networking or scanner modules, special function modules, etc.), variable frequency drives, telemetry devices, safety relays, vision systems, or other such devices.

As illustrated in FIG. 5, during development of a system project 302, a user can interact with the IDE system's development interface to select a device profile 506 to be added to the project 302. The selected profile 506 typically corresponds to a type of device that will be included in the automation system for which the project 302 is being developed. Once a selected device profile 506 has been added to the system project 302 (via submission of profile selection input 504), the user can invoke device configuration interfaces defined by the device profile 506 and interact with these configuration interfaces to set values of device parameters or settings 508 for the device represented by the profile 506. When the system project 302 is subsequently deployed to the industrial controller 118 or other devices that make up the automation system (as illustrated in FIG. 4), the device configuration settings 508 that had been submitted by the user are written to corresponding registers of the relevant field devices (e.g., the industrial controller 118 in the case of I/O modules or smart devices connected to the controller 118, or other target devices that are subject to the device settings).

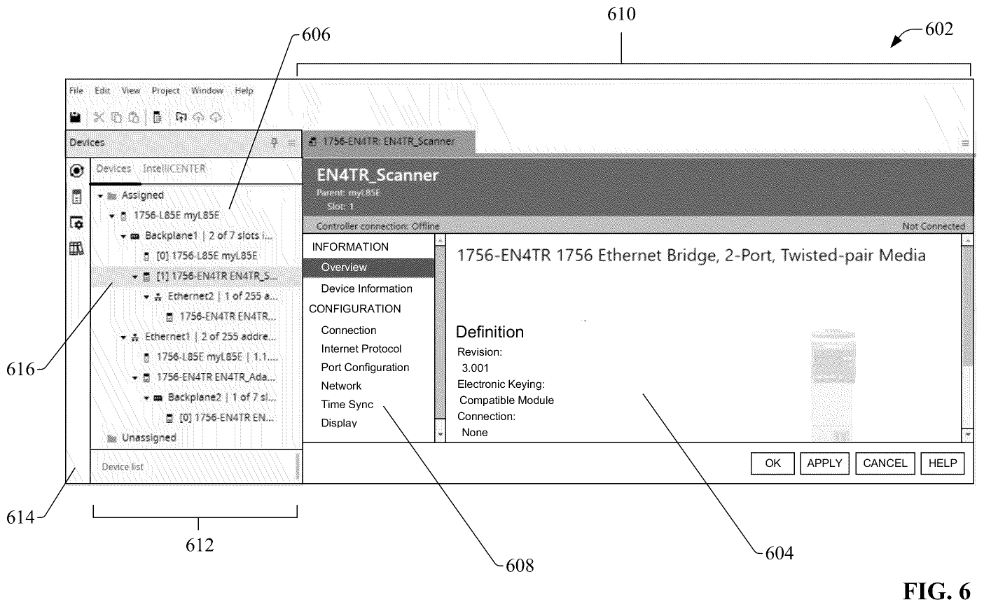

FIG. 6 is an example development interface 602 that can be rendered on a client device 304 by the industrial IDE system's user interface component 204. Development interface 602 is organized into panels and workspaces for navigating and editing the system project 302. The example interface 602 depicted in FIG. 6 comprises a main workspace area 610 that serves as the IDE system's primary work area and an explorer panel 612 located adjacent to the main workspace area 610. The explorer panel 612 displays a navigation tree 606 comprising a hierarchical arrangement of selectable nodes representing elements of the system project 302 being developed. In general, selection of a project element from the navigation tree 606 causes the main workspace area 610 to render project content corresponding to the selected element, such as ladder logic or other types of control code, program routines, controller tag definitions, device configuration information, or other aspects of the project 302. The user can interact with these project elements within the main workspace area 610 to perform such development functions as writing or editing controller code (e.g., ladder logic, function block diagrams, structured text, etc.), configuring device parameter settings, defining controller tags, or other such project development functions.

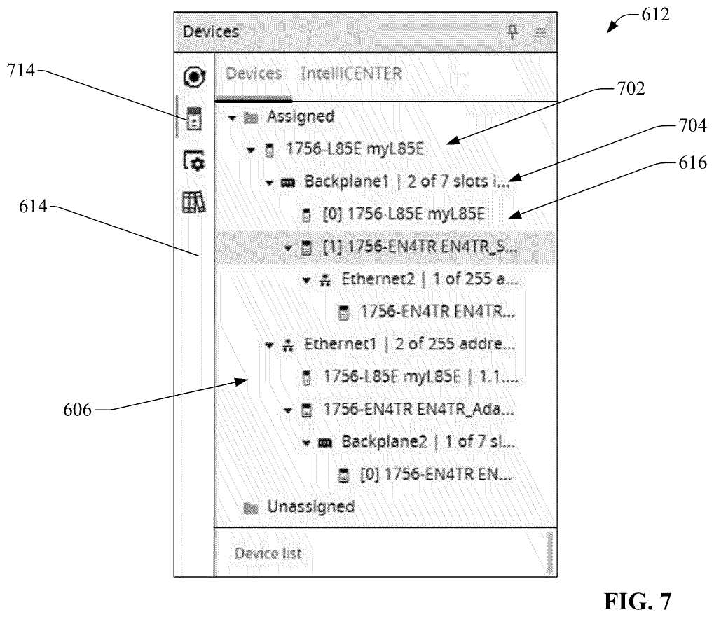

FIG. 7 is a view of the explorer panel 612 and its associated navigation tree 606 in isolation. As noted above, explorer panel 612 serves as a means for navigating and viewing content of a system project 302 and supports various ways for performing this navigation. Selectable viewing categories are rendered as selectable explorer icons in a control bar 614 pinned to the left-side edge of the explorer panel 612. Selection of an explorer icon from the control bar 614 sets the type of project content to be browsed via the Explorer panel 612. In the scenario depicted in FIG. 7, a Devices view icon 714 has been selected in the control bar 614, causing the explorer panel 612 to display, as the navigation tree 606, a hierarchical arrangement of device nodes representing the devices defined for the system project 302.

For an example system project 302, the device navigation tree 606 can include a controller node 702 representing an industrial controller 118 to be programmed as part of the system project 302. A backplane node 704 is defined as a child node of the controller node 702 and represents the backplane of the industrial controller 118 on which one or more devices or modules will be installed. Any modules or devices to be connected to the controller's backplane are represented as device nodes 616 below the backplane node 704. Example devices that can be associated with the controller can include, but are not limited to, digital or analog input modules, digital or analog output modules, networking or scanning modules, analytic modules, special function modules, smart industrial devices, motor drives such as variable frequency drives, or other such devices. Per the workflow illustrated in FIG. 5, a user can add a new device to the project by adding a new device node 616—which in this case represents a device profile 506 for the type of the device—to the device navigation tree 606. Any suitable interaction can be used to add a new device to the navigation tree 606. For example, the user may select the backplane node 704 and invoke a device profile selection window (e.g., by right-clicking on the backplane node 704) that displays a list of available types of devices that can be added to the project 302. In embodiments that support the use of device profiles 506, each device type has a corresponding device profile 506 stored in the system's device profile library 502. The device profile 506 defines information about the corresponding device type, as well as any device parameters associated with the device type whose values can be set by the user.

The explorer icons rendered on the control bar 708 can also include an Application icon that causes the explorer panel 612 to display a list of applications—e.g., industrial control programs such as ladder logic routines—that make up the system project 302. This viewing mode allows the user to develop, view, and edit control programs within the main workspace area 610. These control programs will be installed and executed on the industrial controller 118.

Returning to FIG. 6, selecting a device node 616 in the navigation tree 606 causes the main workspace area 610 to display an interactive device configuration interface for viewing and editing configuration parameters for the selected device. Device information and configurable device parameters displayed on this device configuration interface are defined by the device profile 506 for the selected device. In the example depicted in FIG. 6, the device configuration interface comprises a main configuration area 604 and a category window 608 that lists various informational and configuration categories for the device. Selecting a category from this window 608 causes the main device configuration area 604 to render information or configurable device parameters relating to the selected category.

Informational categories listed in the category window 608 can include an Overview category and a more detailed Device Information category. Selection of the Overview category can cause summary information about the device—e.g., model number and revision number of the device, device type, a type of electronic keying, or other such information—to be rendered in the main workspace area 610. In the example depicted in FIG. 6, the user has selected a device node 616 representing an ethernet bridge module that will be installed on the controller's backplane, and has selected the Overview category within the category window 608 so that general overview information for the module can be viewed.

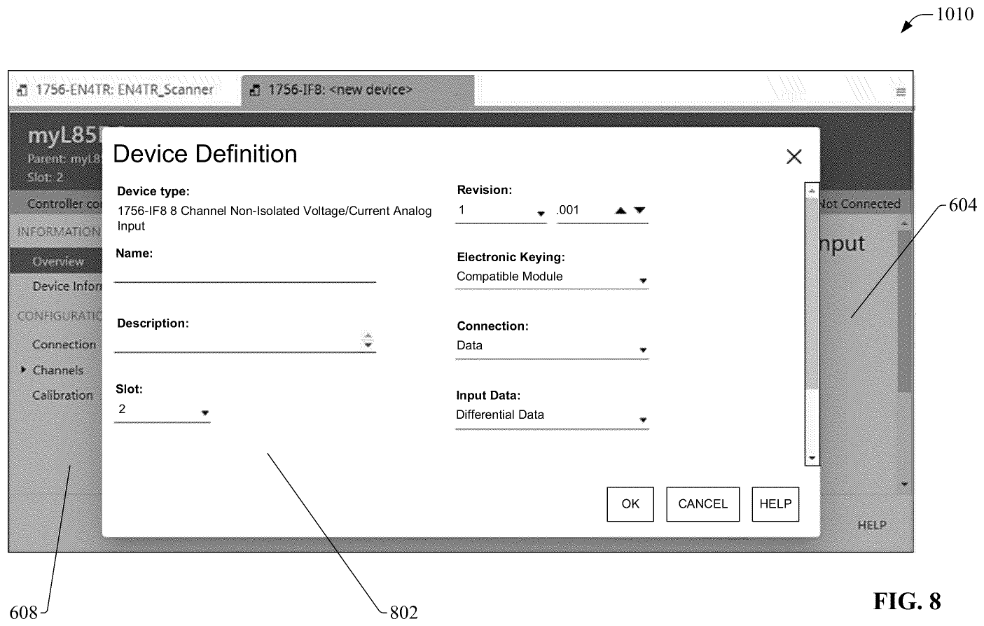

Depending on the type of device, some of the device information accessible via the Overview or Device Information categories can be edited by the user. FIG. 8 is a view of the main workspace area 610 in which a Device Information editing window 802 has been invoked for the selected device. This window 802 includes data fields that allow the user to enter or edit various items of information about the device, including but not limited to a name of the device, a description of the device, a controller slot number in which the device is to be installed (if the device is a module to be installed on a controller backplane), revision information, a type of electronic keying, a type of connection, a type of input data, or other such information.

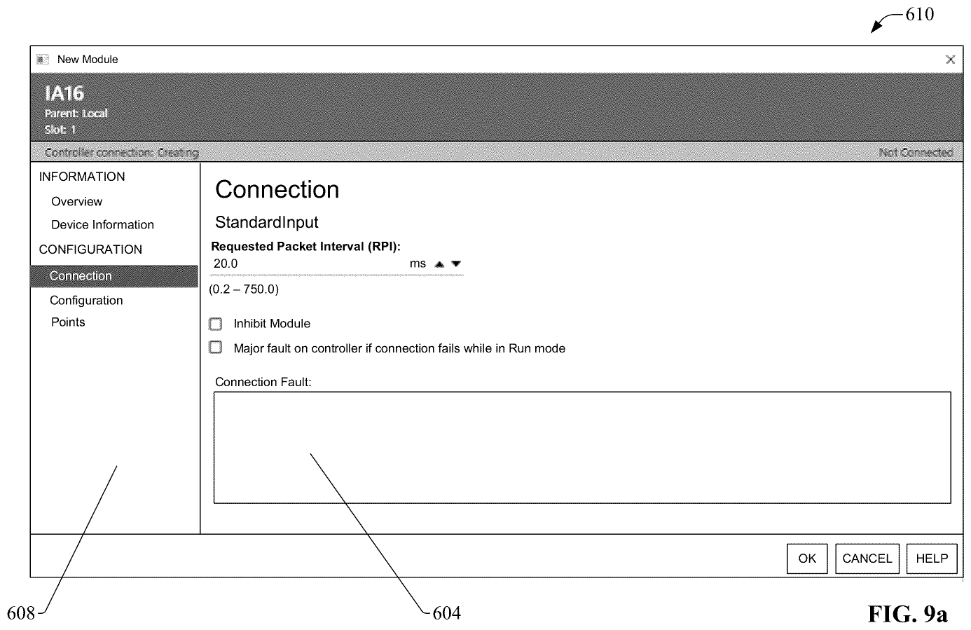

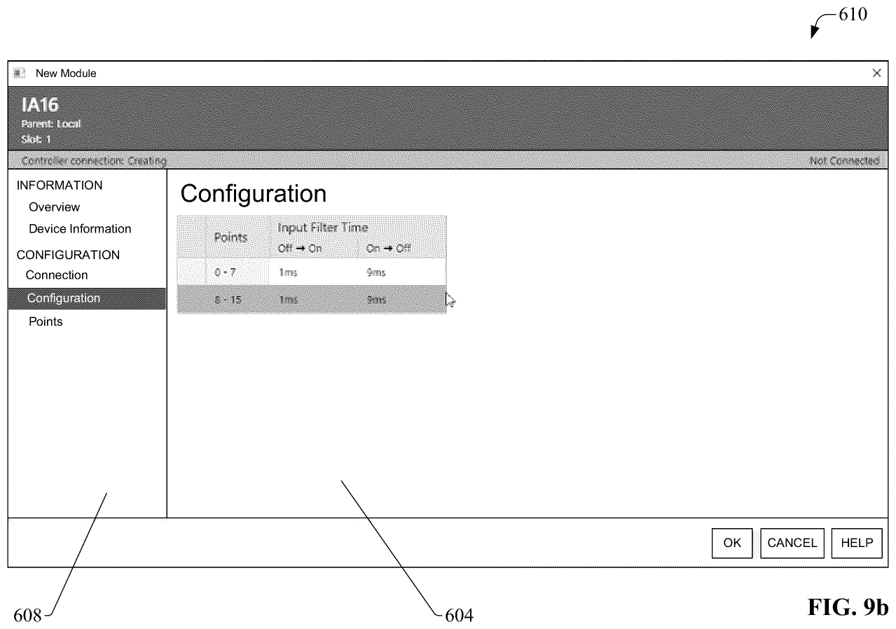

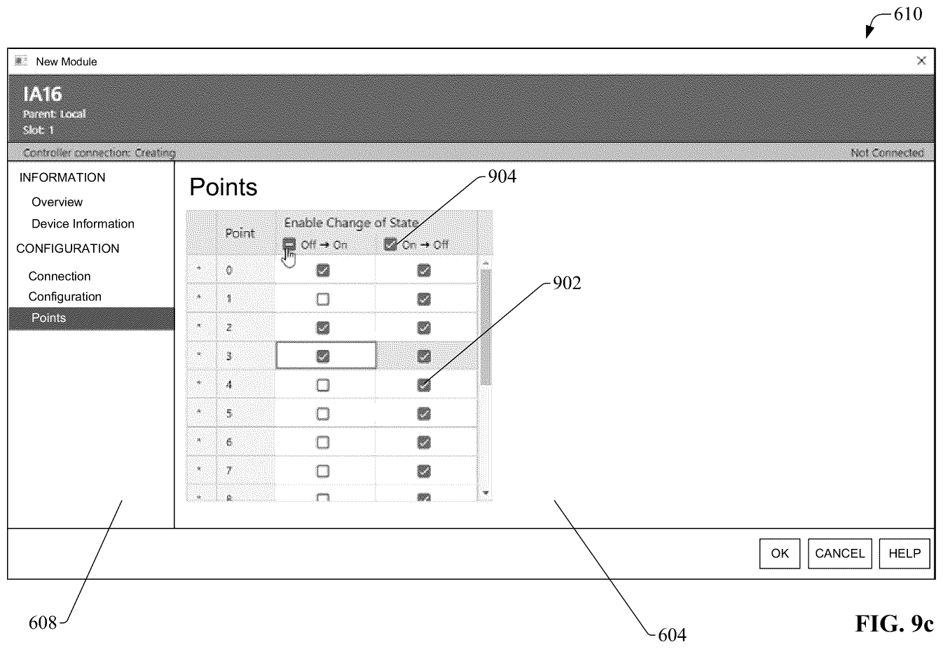

Returning again to FIG. 6, configuration categories listed in the category window 608 can include, for example, a Connection category, an Internet Protocol category, a Port Configuration category, a Network category, a Time Sync category, a Display category, a Channels category, a Calibration category, an I/O points category, or other such configuration categories. The available configuration categories, as well as the specific parameters that are accessible under each category, can depend on the type of device being viewed. For example, FIG. 9a is a view of the main workspace area 610 in which the user has selected a 16-point digital input module. Available configuration categories listed in the Category window 608 for this type of device include a Connection category, a Configuration category, and a Points category. The Connection category has been selected in FIG. 9a, causing the configuration area 604 to display configurable connection parameters for the module. These parameters include a packet interval timing, an indication as to whether the module is to be inhibited, and an indication as to whether a connection failure is to trigger a major fault on the controller 118. The configuration area renders interactive graphical controls—e.g., data entry boxes, drop down selection windows, binary check boxes, etc.—for each configurable parameter to allow the user to enter values of these parameters.

FIG. 9b is a view of the main workspace area 610 in which the Configuration category has been selected in the Category window 608. For the selected analog input module, selecting this category causes the configuration area 604 to display an interactive table that allows the user to set input filter times for groups of input points. FIG. 9c is a view of the main workspace area 610 in which the Points category has been selected in the Category window 608. This invokes another interactive table in the configuration area 604 that allows the user to selectively enable or disable changes of state—both on-to-off and off-to-on transitions—for each input point of the module. In contrast to generic table-based interfaces, this graphical configuration interface comprises both individual checkbox controls 902 that allow the user to enable or disable state changes for individual input points, as well as global checkbox controls 904 that allow the user to enable or disable state changes for all of the module's input points with a single selection input.

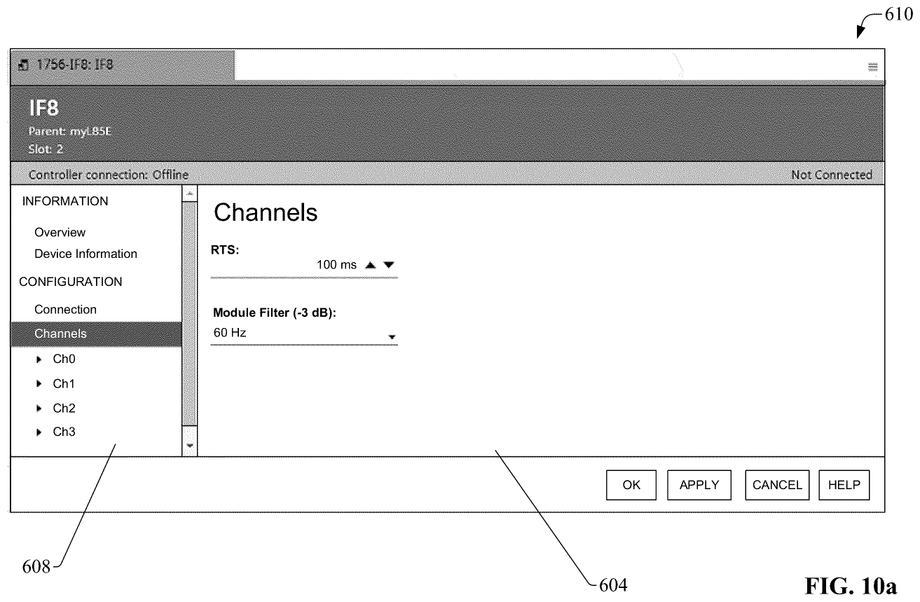

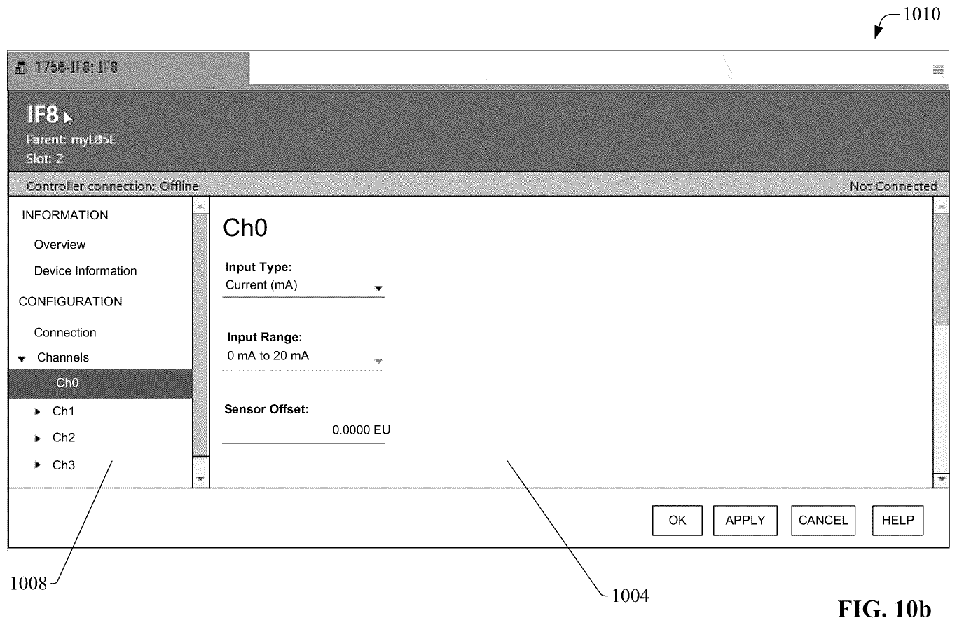

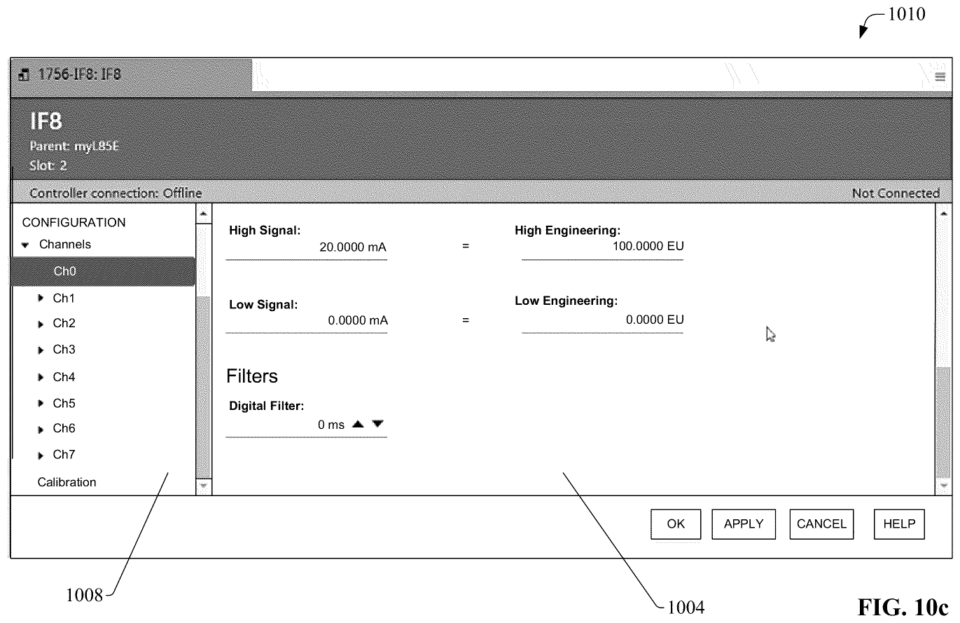

As noted above, the device profile 506 for the device being configured defines the configuration parameters that will be presented for viewing and editing in the main workspace area. FIG. 10a is a view of the main workspace area 610 in which another type of device—an 8-channel analog input module—has been selected. In this scenario, the configuration categories listed in the Category window 608 include a Channels category for configuring the analog input channels of the module. General channel parameters that are applicable to all channels—including the real time sampling (RTS) period and the module filter frequency—are rendered in the configuration area 604 and can be edited by the user. In addition, configuration parameters for each individual channel can be set within the configuration area 604, as shown in FIGS. 10b and 10c. These channel-specific parameters can include, but are not limited to, a type of input signal provided to the channel (e.g., current or voltage), a range of the input signal (e.g., 4-20 milliamp, 0-10 volts, etc.), an offset value for the channel, high and low input signal limits, digital filter value, or other such configuration settings.

As can be seen from the navigation structures and workflows described above in connection with FIGS. 8-10c, the use of device profiles to add and configure devices to a project 302 can involve a considerable number of manual steps to select a desired device type, navigate to the configurable device parameters to be set, and enter values for those parameters. Moreover, if multiple devices are to be added to a project 302, this approach requires each device to be added and configured one device at a time, and does not offer the ability to add multiple configured devices to the project in bulk.

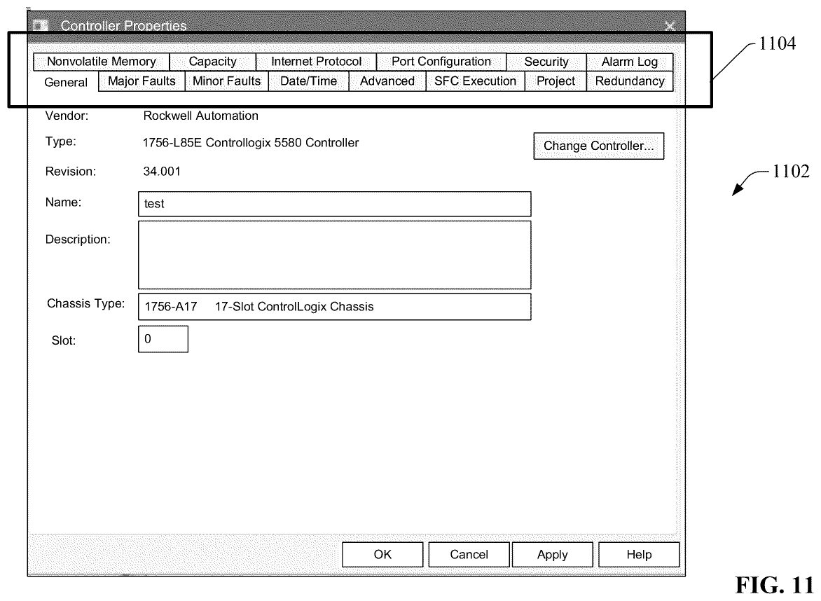

FIG. 11 is a view of another example device configuration interface 1102 illustrating the complex workflow involved in adding a configured device to a control project 302. In this example, interface 1102 is used to configure the properties of an industrial controller to be added to a system project 302. The various categories of configurable device properties are accessed via selectable tabs 1104 arranged on the top of the interface 1102. As such, the workflow for configuring the device using interface 1102 requires the user to perform many navigational steps to select the categories of interest and set the associated parameters. Also, if multiple devices are to be included in a project 302, this process must be performed individually for each device.

To reduce the amount of manual configuration steps required to configure and add device definitions to a control system project 302, one or more embodiments of the IDE system 202 described herein can support a simplified workflow and associated user interfaces for adding device definitions to a project 302. These workflows and interfaces also allow multiple device definitions to be added to a project 302 in bulk using a reduced number of steps and interfaces relative to the approaches described above.

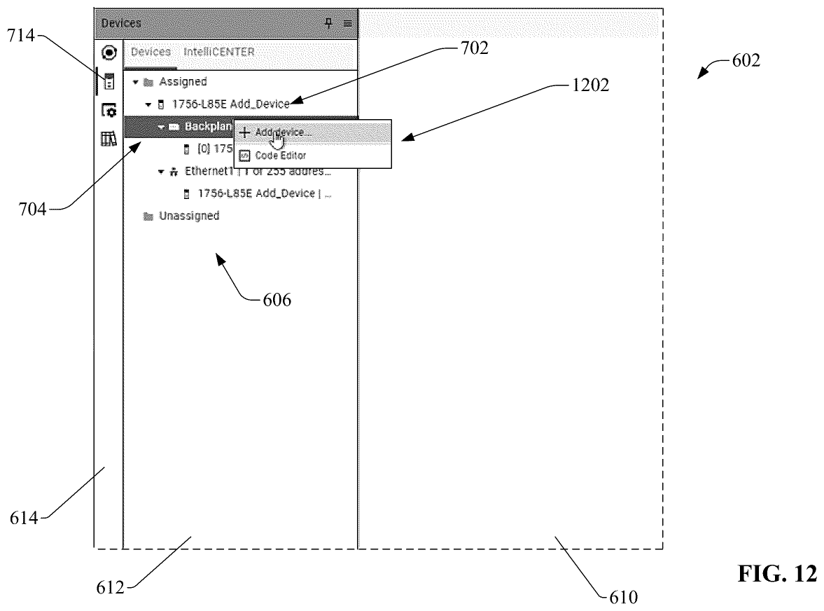

Example workflows supported by embodiments of the IDE system 202 for configuring and adding devices to a system project 302 are now described. FIG. 12 is a view of the explorer panel 612 illustrating an example user interaction for initiating the process of adding devices to a project 302 according to one or more embodiments. When adding device definitions to a project, the IDE system 202 allows the user to either pre-select a device, backplane, or network to which the new devices will be added (e.g., the backplane of an industrial controller to which the user wishes to add I/O modules, an ethernet network to which new devices will be added, etc.) or add the new devices as initially unassigned devices so that the new devices can subsequently be allocated to another device, backplane, or network. In the example depicted in FIG. 12, the user is preselecting a controller backplane to which multiple devices will be added in bulk using a single workflow (that is, without adding each device individually using respective separate device profile interfaces, as described above in connection with FIGS. 8-10c). The user has already added a controller definition to the current project 302, which is represented by controller node 702 and its associated backplane node 704 (a child node of the controller node 702) in the navigation tree 606. To initiate the process of adding new device definitions to the controller's backplane, the user selects the desired backplane node 704 using a right-click action (or another suitable interaction), which invokes an overlay window 1202 having a selectable “Add device . . . ” control. Selecting this item initiates the device selection step.

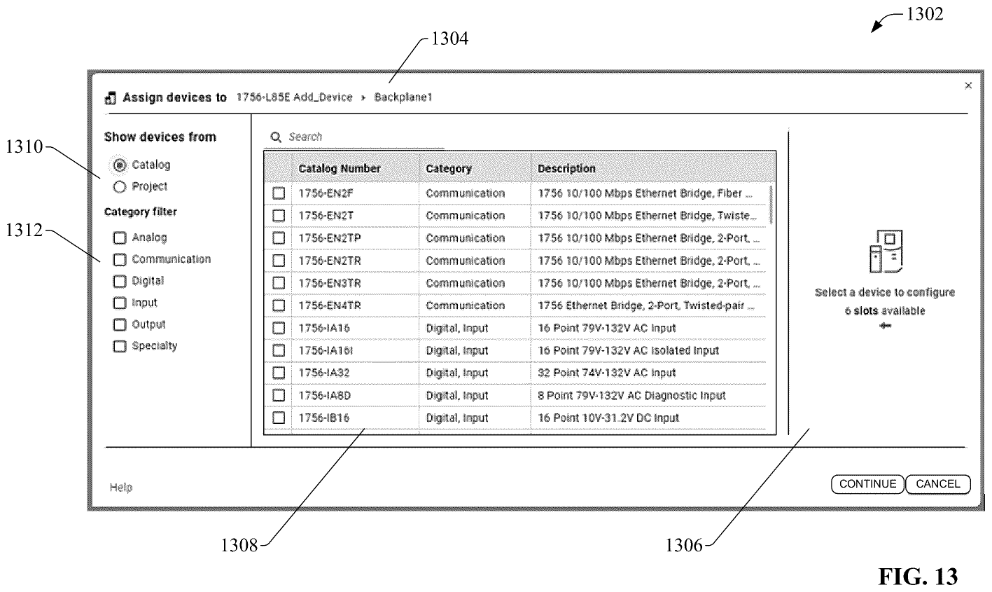

FIG. 13 is an example Device Selection interface 1302 that can be rendered by the user interface component 204 in response to selection of the “Add device . . . ” control. When the user initially specifies the device, backplane, or network to which the new devices will be added, as illustrated in FIG. 12, the Device Selection interface 1302 indicates the selected device, backplane, or network in an Assignment area 1304. Device Selection interface 1302 allows the user to select one or more new devices that are to be added to the project 302 in association with the device, backplane, or network that was selected in the previous step. Accordingly, the Device Selection interface 1302 includes a Device Selection window 1308 that lists devices of various types that are available for selection. Each device entry in the Device Selection window 1308 can include data fields, organized into columns, containing respective types of information about the corresponding device, such as the device's catalog number, a general category into which the device's function is classified (e.g., communication, analog, digital, input, output, specialty, etc.), a description of the device (e.g., an Ethernet bridge, a 16-point analog input module, an 8-point digital output module, etc.), or other such information. To assist in locating devices of interest, the Device Selection interface 1302 can include a Category Filter selection boxes 1312 (or other filtering mechanisms) that allow the user to filter the list of selectable device rendered in the Device Selection window 1308 according to one or more selected device categories (e.g., the categories indicated in the Category column).

If the user has pre-selected the device, backplane, or network to which the new devices will be added, as in the present example, the Device Selection window 1308 will only display devices that are compatible with the selected device, backplane, or network, omitting devices that are not compatible with the selected device, backplane, or network. This filtering of selectable devices according to the known constraints of the target device to which the new devices will be assigned can assist the user in quickly and easily locating new devices that are known to operate with the target device.

Device Selection interface 1302 also includes a control area 1310 that allows the user to select whether the Device Selection window 1308 renders all devices that are defined in the IDE system's device catalog that are compatible with the target device, backplane, or network (e.g., by selecting a “Catalog” radio button) or, alternatively, whether the Device Selection window 1308 displays only devices that have already defined and added to the project 302 (e.g., by selecting a “Project” radio button) and that are compatible with the target device.

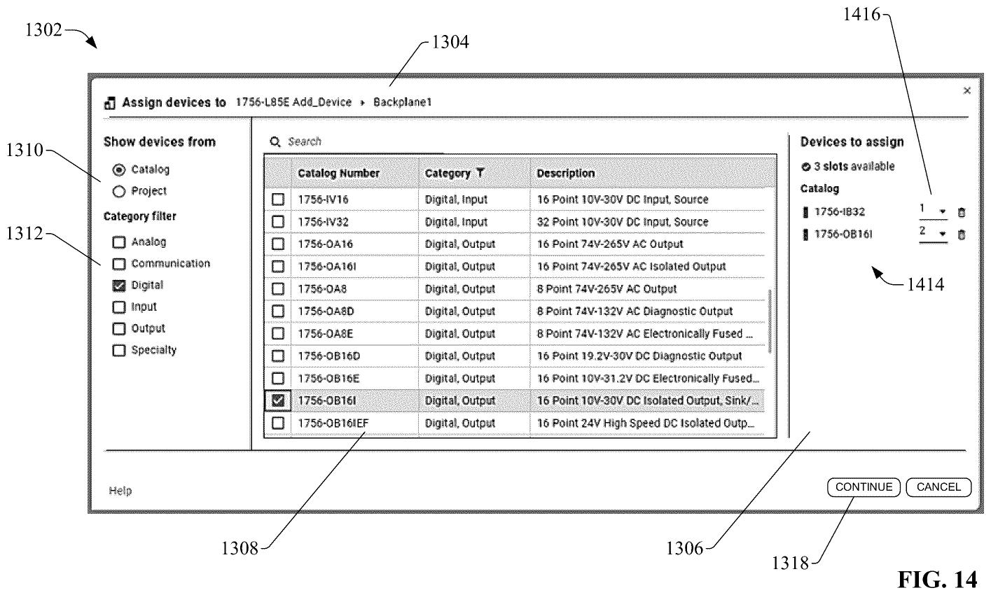

FIG. 14 is a view of the Device Selection interface 1302 in which the user has selecting two devices from the Device Selection window 1308. In the illustrated example, each device entry listed in the Device Selection window 1308 includes an associated checkbox. Selecting a device entry's checkbox causes the corresponding device to be added to a list 1414 of selected devices displayed in a Selected Devices window 1306 of the Device Selection interface 1302 (labeled “Devices to assign”). In the example illustrated in FIG. 14, the user has selected two I/O modules having catalog numbers 1756-IB32 and 1756-OB16I from the Device Selection window 1308; accordingly, these devices are listed in the Selected Devices window 1306. The user may remove a selected device from the list 1414 by unselecting the checkbox corresponding to that device. Since the selected devices are to be added to the backplane of an industrial controller, which has a limited number of available slots in which I/O or specialty modules can be installed, the Selected Devices window 1306 renders a data entry field 1416 next to each of the two selected devices in the list 1414 for specifying a number of instances of the device is to be added to the project 302. The Selected Devices window 1306 can also render other information about the selected devices or about the device, backplane, or network to which the selected devices will be assigned (e.g., the number of slots currently available on the controller).

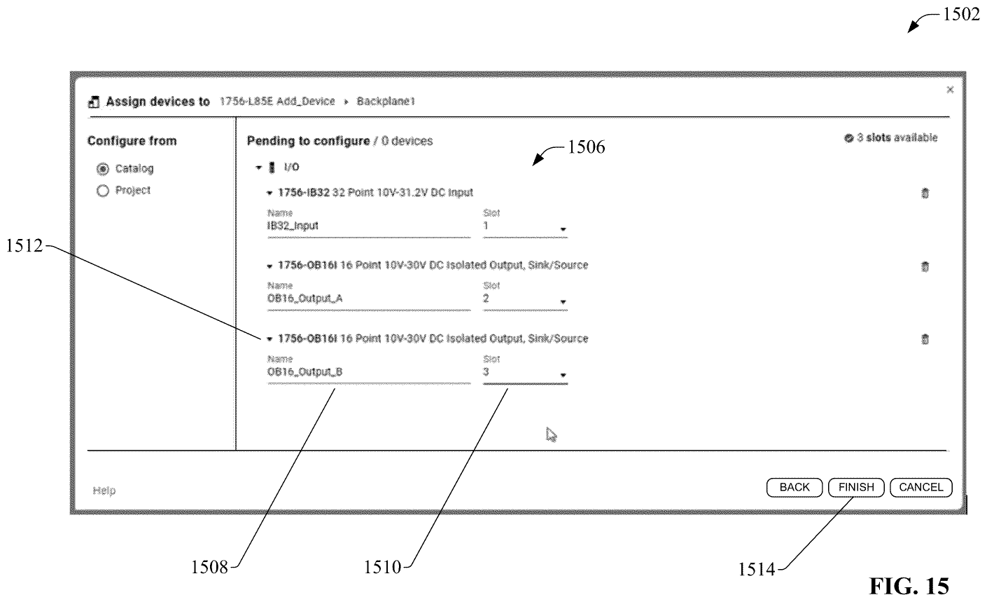

The user can select any number of devices for inclusion in the Selected Devices list 1414, including devices of multiple different types. Once the user has selected all desired devices that are to be added to the project 302 for the current configuration session, selecting the Continue button 1318 on the Device Selection interface 1302 causes the workflow to proceed to the device configuration stage. FIG. 15 is an example Device Configuration interface 1502 that can be rendered by the user interface component 204 when the user selects the Continue button 1318. Device Configuration interface 1502 renders a list 1506 of the devices that were selected in the previous step using Device Selection interface 1302, and allows the user to enter configuration information for each device in the list 1506. In the illustrated example, three devices were selected in the previous step: a 32-Point 10V-31.2V DC Input module (catalog number 1456-IB32) and two 16-Point 10V-30V DC Isolated Output modules (catalog number 1456-GB16I).

For each selected device in the list 1506, the Device Configuration interface 1502 displays a device identifier 1512 (e.g., a catalog number and/or description of the device) as well as user controls for setting values of the device's configurable parameters. The configurable parameters displayed by the Device Configuration interface 1502 for a given device can depend on the type of device being configured. In the case of the example I/O modules displayed in FIG. 15, each device has an associated Name field 1508 for entering a name of the device as well as a Slot selection field 1510 for selecting an identifier of a controller slot in which the module will be installed. The Device Configuration interface 1502 can display other sets of configurable parameters for other types of devices if appropriate, including any of the device configuration parameters discussed above as being configured via the device profile interfaces of FIGS. 8-10c.

Since the Device Configuration interface 1502 consolidates all pending new devices onto a common interface for configuration, all of the pending devices can be configured with minimal navigational steps using the common interface 1502 (e.g., without the need to navigate to separate device profile interfaces for the respective new devices). Additionally, the Device Configuration interface 1502 can provide real-time feedback that assists the user in identifying and configuring required parameter settings and ensures that each user-defined parameter entry satisfies value range or formatting constraints. For example, the Device Configuration interface 1502 can render a graphical indicator near each parameter field requiring input from the user, and can also render an error message near each parameter field in which the user has entered an invalid parameter value (as determined based on known valid value ranges or formats for each parameter, which are defined in the IDE system's library).

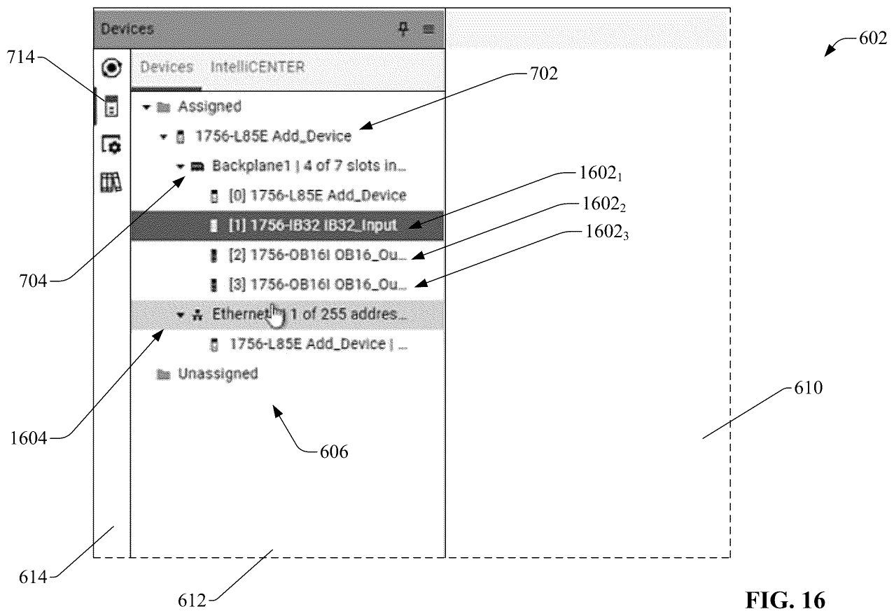

After the user has entered values for the respective devices' configurable parameters, selecting a Finish button 1514 on the Device Configuration interface 1502 causes the selected and configured devices to be added to the project and allocated to controller that was selected as described above in connection with FIG. 12. FIG. 16 is a view of the explorer panel 612 illustrating the updated project navigation tree 606 after the three devices have been added to the project 302 using the workflow described above in connection with FIGS. 12-15. In response to selection of the Finish button 1514, the Device Configuration interface 1502 is removed from the development interface 602, and the navigation tree 606 is updated to add three new device nodes 1602₁-1602₃ representing the three new devices, respectively. The new device nodes 1602₁-1602₃. Since the user had initially invoked the Device Selection interface 1302 via interaction with the backplane node 704 associated with the controller node 702, the new device nodes 1602₁-1602₃ are added as child nodes of the backplane node 704. The new device nodes 1602₁-1602₃ can be labeled with the device names entered by the user via Device Configuration interface 1502, and can also be labeled with slot number indicators conveying the respective controller slot numbers in which the respective new devices reside (as defined using the Slot selection fields 1510 of Device Configuration interface 1502).

Although the example workflow described above considered a scenario in which three new devices were added, any number of devices can be added in bulk using interfaces 1302 and 1502. This approach allows multiple devices, including heterogeneous sets of devices of different types, to be selected for addition to a project 302 from a common interface 1302, and also allows these multiple devices to be manually configured using a common interface 1502 that lists all the selected devices together with their editable device parameters. Upon completion of these selection and configuration steps, all of the configured devices are added substantially simultaneously to the project 302. This workflow eliminates the need to individually select, configure, and add each device using its dedicated device profile interface, as described above in connection with FIGS. 8-10c.

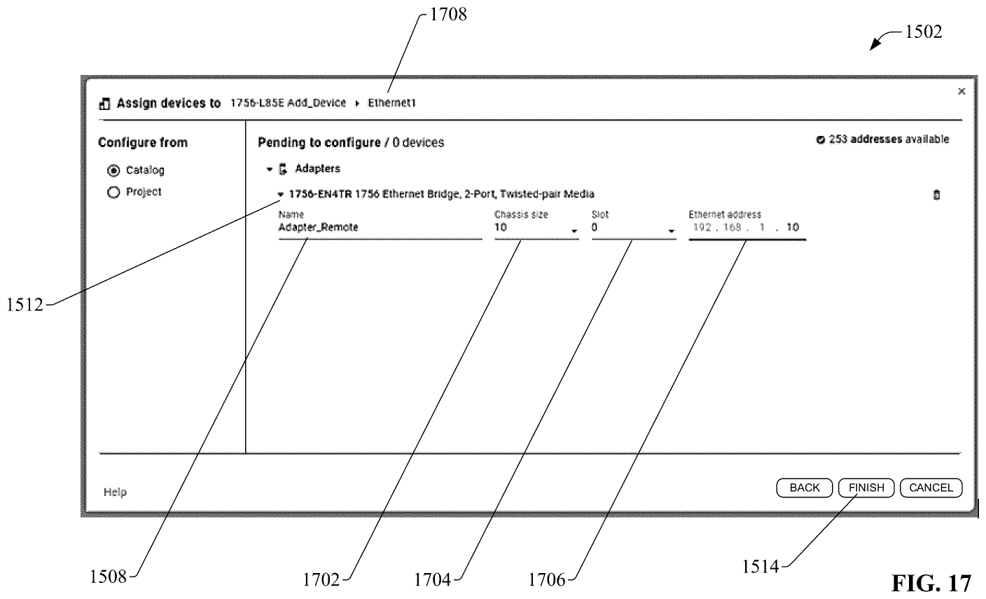

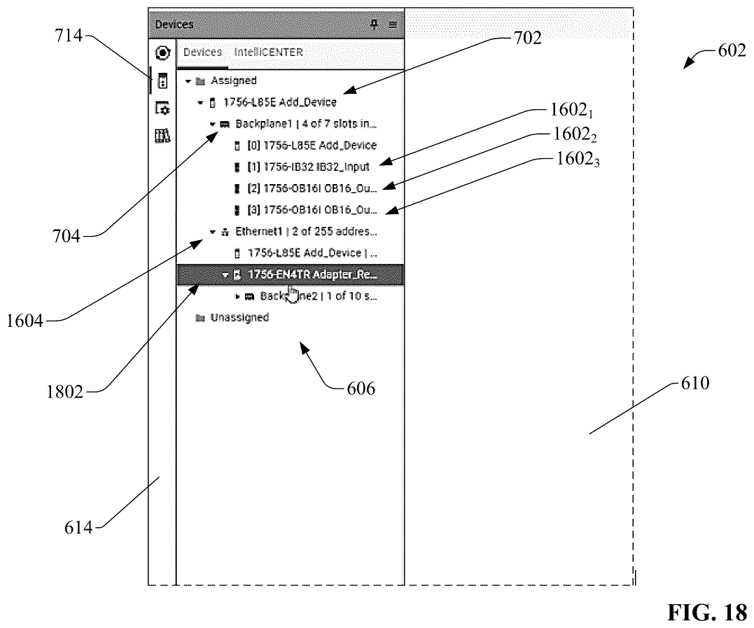

FIG. 17 is another view of Device Configuration interface 1502 illustrating configuration of another type of device. In this example, rather than an I/O module being added to an industrial controller, the new device is an ethernet bridge device to be added to an ethernet network defined as part of the system project 302. The ethernet network to which the ethernet bridge will be added is represented in the navigation tree 606 by network node 1604 in FIG. 16. To add the ethernet bridge device to the project and assign the device to the ethernet network in a single workflow, the user can invoke Device Selection interface 1302 via a suitable interaction with the network node 1604 (e.g., a right-click interaction) and select the desired ethernet bridge device using Device Selection interface 1302 as described above in connection with FIG. 13. The user can then proceed to the Device Configuration interface 1502 shown in FIG. 17 to configure the device. The ethernet network to which the device will be added is identified in an Assignment area 1708 of the interface 1502. As shown in this example, the configurable parameters for the ethernet bridge device differ from those of the I/O modules depicted in FIG. 15. Specifically, in addition to the Name field 1508, the interface 1502 renders a Chassis Size field 1702, a Slot field 1704, and an Ethernet address field 1706, which can be used to set values for those respective device properties. As in the previous example, selecting the Finish button 1514 causes the configured device to be added to the project 302. FIG. 18 is a view of the explorer panel 612 illustrating the updated project navigation tree 606 after the ethernet bridge device has been added to the project 302.

In general, the configurable device properties rendered by the Device Configuration interface 1502 for a given device is a function of the device type. For some device types, the Device Configuration interface 1502 may render only a subset the total available device parameters for that device type, corresponding to the parameters most often modified by end users. In such cases, the system can omit other device parameters that are rarely modified from their default values from the main Device Configuration interface 1502, making those parameters accessible via another user control (e.g., an Advanced Configuration button). To determine which device parameters are most frequently modified by customers, the IDE system 202 can track user interactions with instances of the Device Configuration interface 1502 to determine the numbers of times that respective different device parameters were modified by users when the Device Configuration interface 1502 was invoked. Based on this information, the user interface component 204 can render only those device parameters determined to be modified in excess of a specified number of times on the main Deice Configuration interface 1502, while relegating other device parameters to a separate Advanced configuration interface.

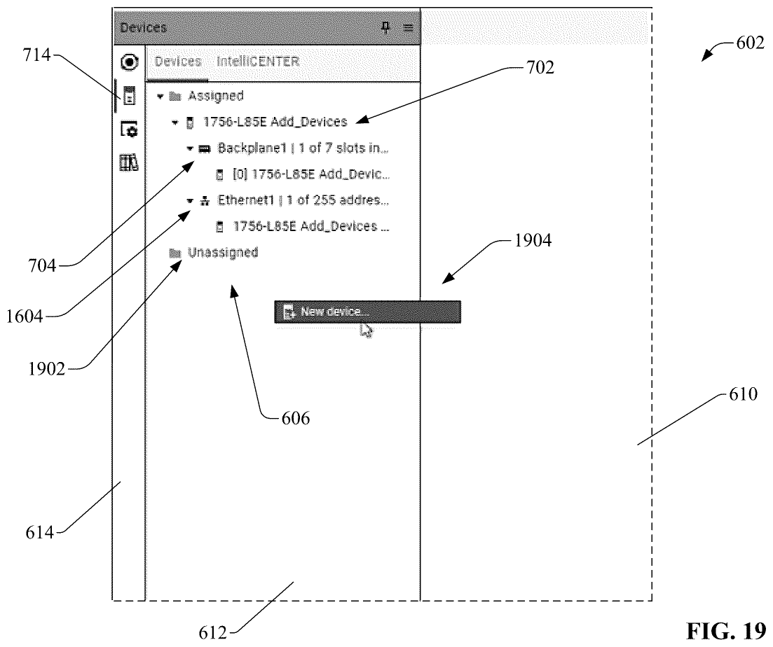

In the examples described above in connection with FIGS. 12-19, the user pre-selected (from the project navigation tree 606) the device, backplane, or network to which the new devices were to be added. This workflow allowed the new device to be added to the project 302 and associated with the selected device, backplane, or network with a single workflow. The IDE system 202 also allows users to add the new devices as initially unassigned devices—that is, without initially declaring the device's assignment—so that the new devices can subsequently be allocated to another device, backplane, or network. An example of this workflow is now described. FIG. 19 is a view of the explorer panel 612 illustrating the initiation of a workflow for adding a new device without initially assigning the new device to another device, backplane, or network. In this example, rather than invoking an Add Device window 1202 by interacting with a device, backplane, or network node of the navigation tree 606 (as in FIG. 12), the user can invoke a New Device window 1904 by interacting with an empty point within the explorer panel 612 (e.g., by right-clicking on the background area of the explorer panel 612). The New Device window 1904 has a New Device selection control that, when selected, initiates the process of selecting and configuring a new device.

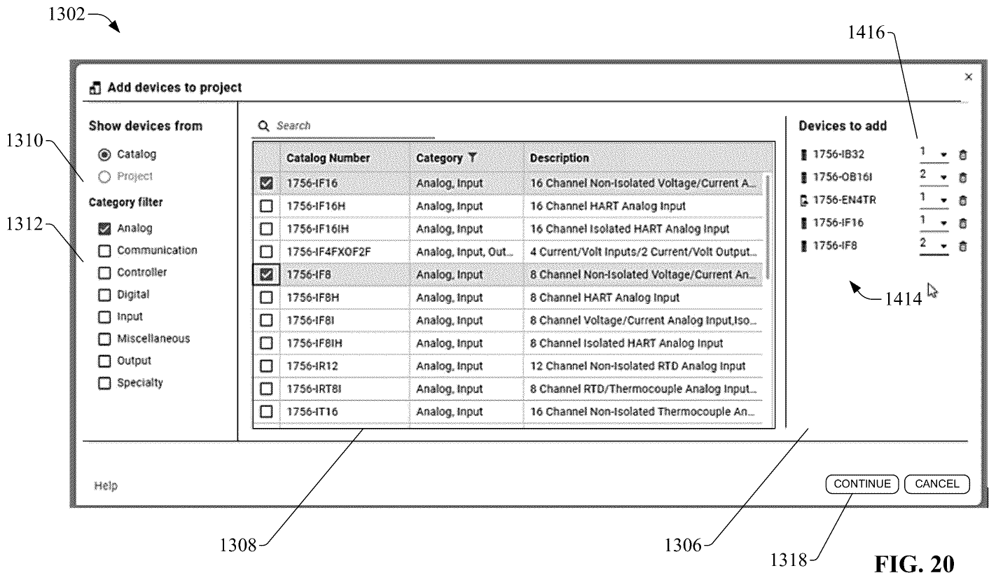

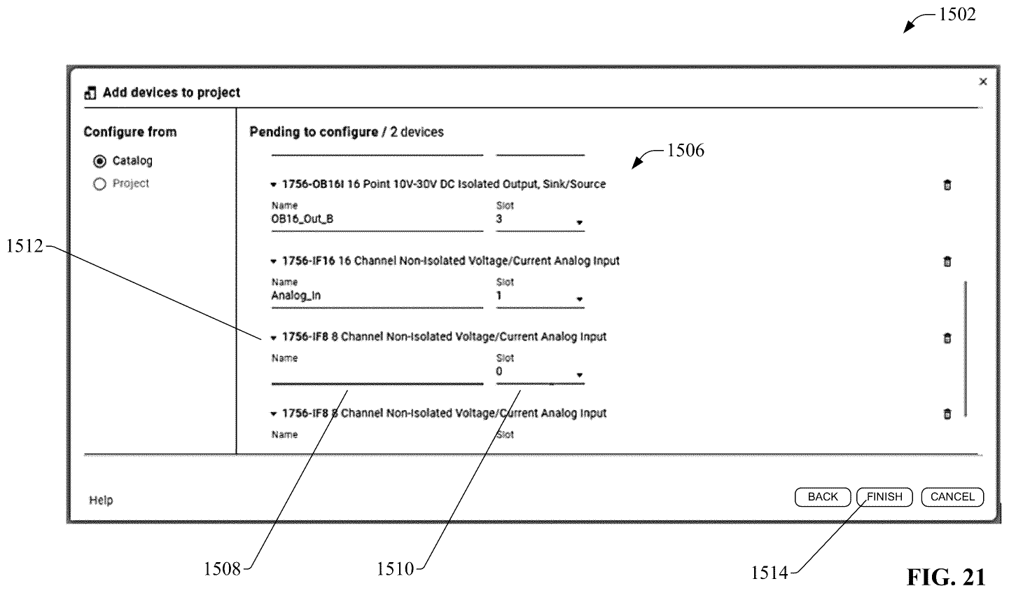

The process of selecting and configuring new devices in this scenario is similar to that described above for the scenario of pre-assigning the new devices to a device, backplane, or network. Selection of the New Device selection control of the New Device window 1904 invokes the Device Selection interface 1302. FIG. 20 is a view of the Device Selection interface 1302 depicting a scenario in which the user has selected seven new devices to be added to the project. As in previous examples, these new devices were selected from the Device Selection window 1308 and added to the list 1414 of selected devices displayed in a Selected Devices window 1306 (note that the user has selected a quantity of 2 in the data entry fields 1416 for two of the devices in the list 1414). Once the desired devices have been selected, the user can proceed to the Device Configuration interface 1502 by selecting the Continue button 1318. FIG. 21 is a view of the Device Configuration interface 1502 as the seven new devices are being configured (as described above in connection with FIG. 15). Once the new devices have been configured, selecting the Finish button 1514 removes the Device Configuration window 1502 returns the user to the development interface 602, and adds the selected and configured devices to the project 302.

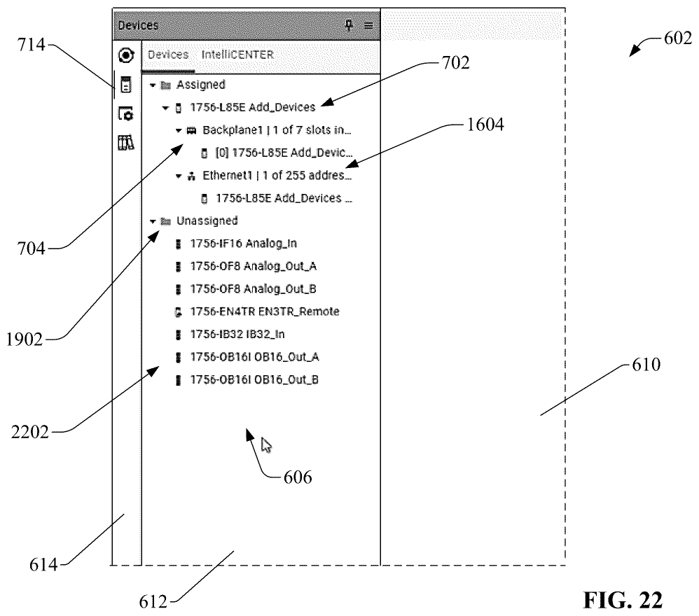

FIG. 22 is a view of the explorer panel 612 depicting the updated project navigation tree 606 after the seven new devices have been added to the project 302 using the workflow described above in connection with FIGS. 19-21. Since the user did not initially specify a device, backplane, or network to which the new devices would be assigned, the user interface component 204 adds the new device nodes 2202 below an Unassigned folder node 1902 of the navigation tree 606 rather than adding the new device nodes 2202 as child nodes of a device, backplane, or network node. With the new devices now added to the project 302 but not yet assigned, the user can assign the new devices to respective devices, backplanes, or networks using the Device Selection interface 1302.

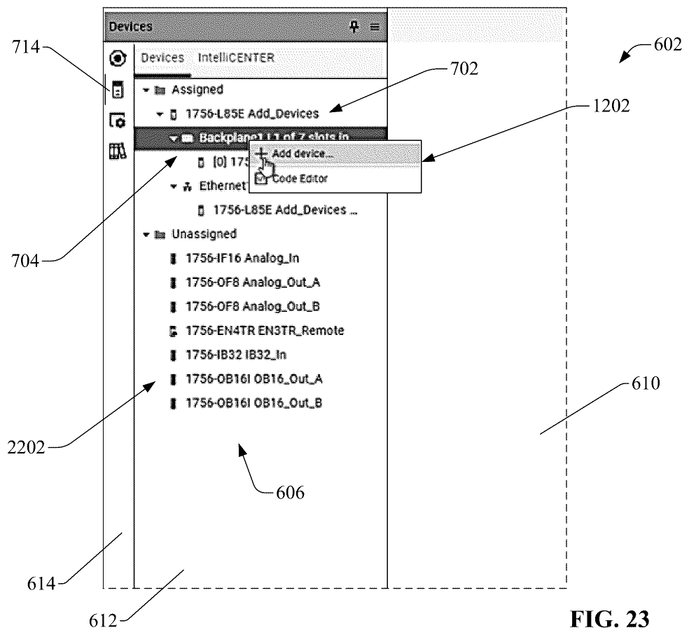

FIG. 23 is a view of the explorer panel 612 in which the user has selected a device from the navigation tree 606 to which one or more of the unassigned devices will be added. To assign one or more of the new unassigned devices to a device, backplane, or network, the user can invoke the Add Device window 1202 by right-clicking on the node of the navigation tree 606 representing the desired device, backplane, or network, and selecting the “Add device . . . ” control (in the illustrated example, the user has selected the backplane node 704). This invokes the Device Selection interface 1302, which allows the user to select the devices to be added to the selected backplane.

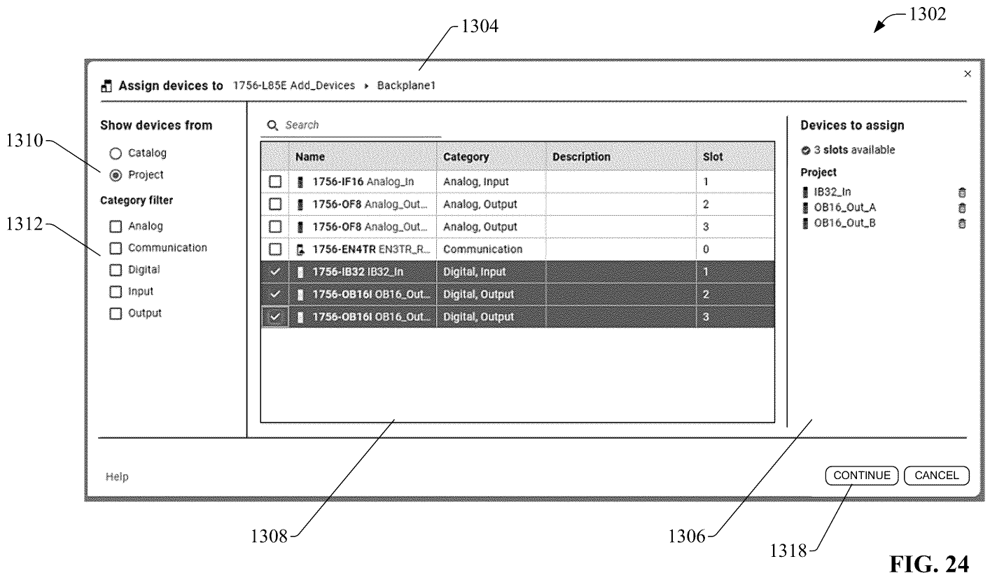

FIG. 24 is a view of the Device Selection interface 1302 in which the user has selected multiple unassigned devices that are to be assigned to the selected backplane. Since the user intends to assign one or more devices that have already been created and added to the project 302 (represented by the unassigned device nodes 2202) rather than creating a new device for assignment to the backplane, the user selects the Project radio button in control area 1310 rather than the Catalog radio button. Whereas selection of the Catalog radio button causes the Device Selection window 1308 to display all devices in the IDE system's device catalog that are compatible with the selected backplane, selection of the Project radio button causes the Device Selection window 1308 to display only devices that have already been added to the project 302 as unassigned devices (represented by unassigned device nodes 2202) and that are compatible with the selected backplane. In the illustrated example, the user has selected three of the currently unassigned devices to be assigned to the backplane that was selected in FIG. 23. The selected devices are listed in the Selected Devices window 1306 of the Device Selection interface 1302.

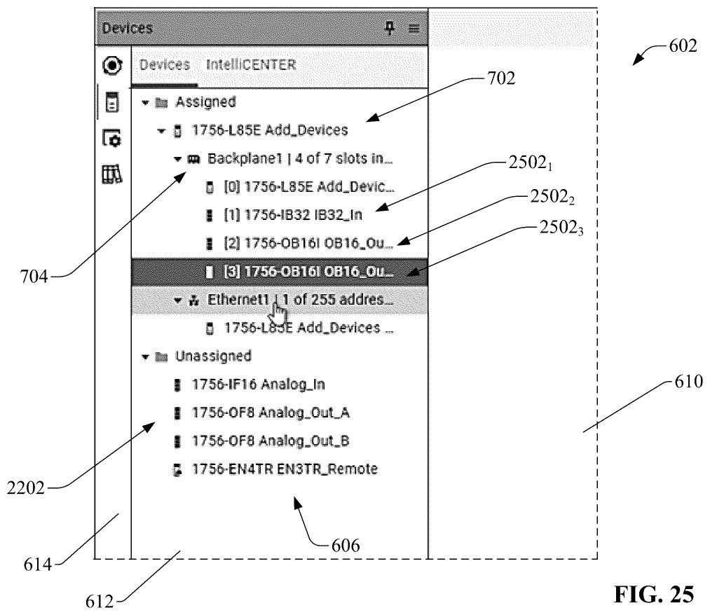

With these devices selected, the user can select the Continue button 1318 to assign the three devices to the backplane. FIG. 25 is a view of the explorer panel 612 after the user has selected the Continue button 1318. The three previously unassigned devices that were selected in FIG. 24 have been removed from the set of unassigned nodes 2202 and are now represented as device nodes 2502₁-2502₃ below the backplane node 704, indicating that the devices corresponding to nodes 2502₁-2502₃ are now assigned to the backplane that was selected in FIG. 23.

The control project development interfaces and workflows described herein allow multiple device definitions to be added to an industrial control project substantially simultaneously using a simple user workflow that reduces the number of navigational steps and repetitive development tasks relative to adding devices to the project one at a time. The IDE system's project development platform allows multiple devices of various device types to be selected using a single selection interface 1302, and also allows those selected devices to be quickly and easily configured using a single configuration interface 1502. This approach eliminates the need to select, configure, and add each device individually, thus reducing engineering time and manual configuration effort. The development platform also allows multiple devices to be assigned to a specified device, backplane, or network as part of the same device creation and configuration workflow, while also affording the option to create new devices as initially unassigned devices for subsequent assignment to a selected device, backplane, or network.

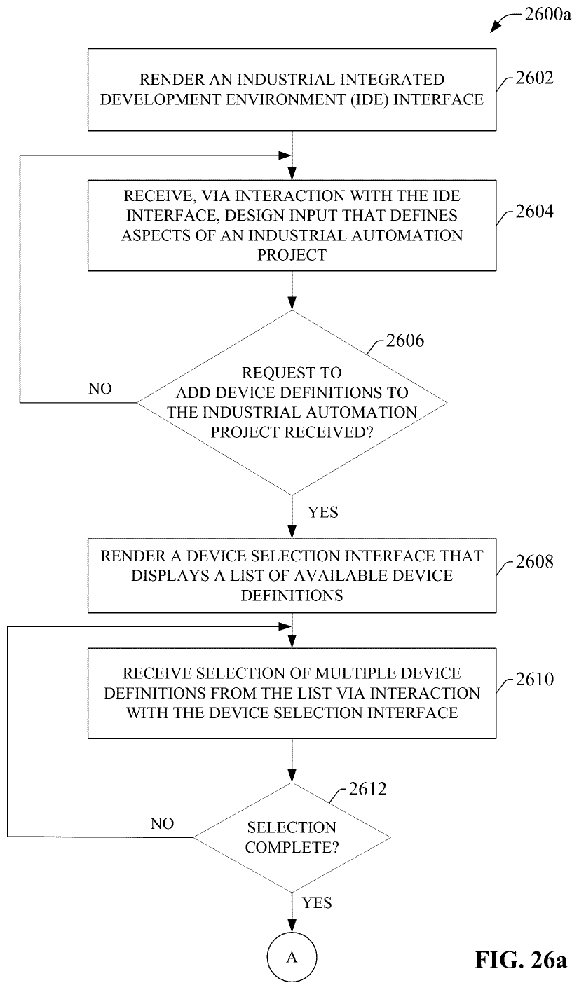

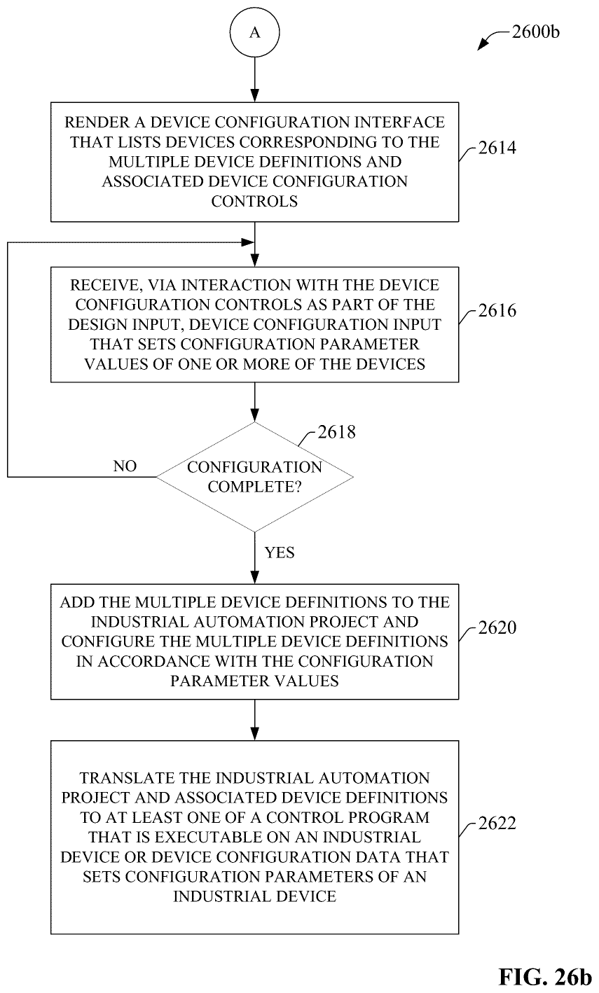

FIGS. 26a-26b illustrate a methodology in accordance with one or more embodiments of the subject application. While, for purposes of simplicity of explanation, the methodology shown herein is shown and described as a series of acts, it is to be understood and appreciated that the subject innovation is not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation. Furthermore, interaction diagram(s) may represent methodologies, or methods, in accordance with the subject disclosure when disparate entities enact disparate portions of the methodologies. Further yet, two or more of the disclosed example methods can be implemented in combination with each other, to accomplish one or more features or advantages described herein.

FIG. 26a illustrates a first part of an example methodology 2600a for adding and configuring multiple device definitions to an industrial automation or control project in bulk. Initially, at 2602, an industrial IDE interface is rendered on a client device. The IDE interface can be generated by an industrial IDE system and can serve as a visual workspace for creating industrial automation projects for deployment and execution on industrial control devices. At 2604, design input that defines aspects of the industrial automation project is received via interaction with the IDE interface rendered at 2602. This design input can define such aspects as control programming to be executed on an industrial controller, definitions of industrial devices that are part of the automation system for which the project is being developed, device configuration settings for the industrial devices, or other such design input.

At 2606, a determination is made as to whether a request to add device definitions to the industrial automation project has been received via interaction with the IDE interface. In some embodiments, this request can be received by invoking a menu window having a selectable option to add one or more devices to the project. At this step, the user can opt to add the new devices as child devices of a selected parent device, backplane, or network already defined in the project, or can opt to add the new devices as being initially unassigned to a parent device. If a request to add device definitions is received (YES at step 2606), the methodology proceeds to step 2608, where a device selection interface is rendered that displays a list of available device definitions. If the user had requested the new devices to be added as children of a selected parent device, backplane, or network, the device selection interface can present a filtered list of available devices that are compatible with the selected parent.

At 2610, selection of multiple device definitions from the list of available devices is received via interaction with the device selection interface rendered at step 2608. At 2612, a determination is made as to whether the user has finished selecting devices. This determination can be made, for example, when the user selects a suitable control on the device selection interface (e.g., a Continue button). When the user indicates that selection is complete (YES at step 2612), the methodology proceeds to the second part 2600b illustrated in FIG. 26b.

At 2614, a device configuration interface is rendered that lists devices corresponding to the multiple device definitions that were selected at step 2610 and, for each device, associated device configuration controls. The device configuration controls associated with a given device can depend on the type of the device, and correspond to configuration settings or parameters that can be edited by the user for that device type. Example settings can include, for example, a name of the device, a controller slot number in which the device is to be installed, a network address of the device, a chassis size of the device, or other such parameters. At 2616, device configuration input is received via interaction with the device configuration controls of the device configuration interface. This device configuration input sets configuration parameter values of the one or more devices. At 2618, a determination is made as to whether the user has finished setting configuration parameter values for the selected devices (e.g., based on the user's selection of a Continue button or other type of control). When the user has completed device configuration (YES at step 2618), the methodology proceeds to step 2620, where the multiple device definitions selected at step 2610 are added to the industrial automation project and configured in accordance with the configuration parameter values set at step 2616. At 2622, the industrial automation project and associated device definitions and configuration parameter values are translated by the IDE system to at least one of a control program that is executable on an industrial device or device configuration data that sets configuration parameters of an industrial device, where the control programs and configuration parameters configure their associated devices to perform monitoring and control of an industrial automation system in accordance with the design input used to create the automation project.

Embodiments, systems, and components described herein, as well as control systems and automation environments in which various aspects set forth in the subject specification can be carried out, can include computer or network components such as servers, clients, programmable logic controllers (PLCs), automation controllers, communications modules, mobile computers, on-board computers for mobile vehicles, wireless components, control components and so forth which are capable of interacting across a network. Computers and servers include one or more processors-electronic integrated circuits that perform logic operations employing electric signals-configured to execute instructions stored in media such as random access memory (RAM), read only memory (ROM), a hard drives, as well as removable memory devices, which can include memory sticks, memory cards, flash drives, external hard drives, and so on.

Similarly, the term PLC or automation controller as used herein can include functionality that can be shared across multiple components, systems, and/or networks. As an example, one or more PLCs or automation controllers can communicate and cooperate with various network devices across the network. This can include substantially any type of control, communications module, computer, Input/Output (I/O) device, sensor, actuator, and human machine interface (HMI) that communicate via the network, which includes control, automation, and/or public networks. The PLC or automation controller can also communicate to and control various other devices such as standard or safety-rated I/O modules including analog, digital, programmed/intelligent I/O modules, other programmable controllers, communications modules, sensors, actuators, output devices, and the like.

The network can include public networks such as the internet, intranets, and automation networks such as control and information protocol (CIP) networks including DeviceNet, ControlNet, safety networks, and Ethernet/IP. Other networks include Ethernet, DH/DH+, Remote I/O, Fieldbus, Modbus, Profibus, CAN, wireless networks, serial protocols, and so forth. In addition, the network devices can include various possibilities (hardware and/or software components). These include components such as switches with virtual local area network (VLAN) capability, LANs, WANs, proxies, gateways, routers, firewalls, virtual private network (VPN) devices, servers, clients, computers, configuration tools, monitoring tools, and/or other devices.

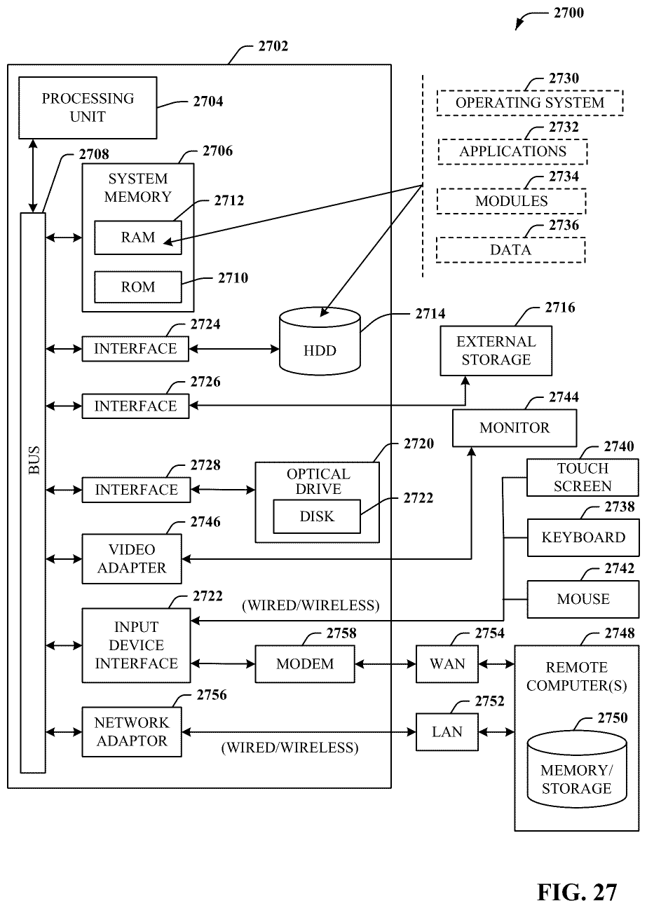

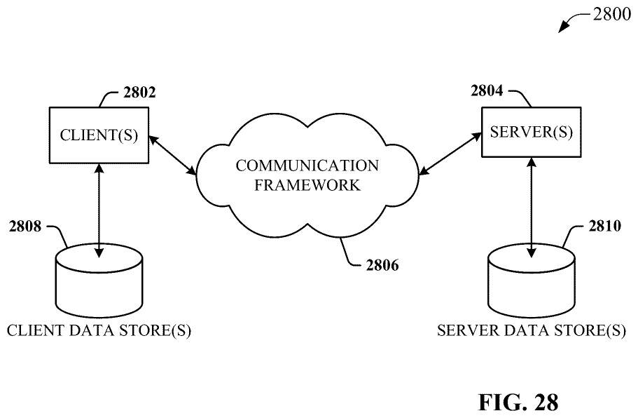

In order to provide a context for the various aspects of the disclosed subject matter, FIGS. 27 and 28 as well as the following discussion are intended to provide a brief, general description of a suitable environment in which the various aspects of the disclosed subject matter may be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 27, the example environment 2700 for implementing various embodiments of the aspects described herein includes a computer 2702, the computer 2702 including a processing unit 2704, a system memory 2706 and a system bus 2708. The system bus 2708 couples system components including, but not limited to, the system memory 2706 to the processing unit 2704. The processing unit 2704 can be any of various commercially available processors. Dual microprocessors and other multi-processor architectures can also be employed as the processing unit 2704.

The system bus 2708 can be any of several types of bus structure that can further interconnect to a memory bus (with or without a memory controller), a peripheral bus, and a local bus using any of a variety of commercially available bus architectures. The system memory 2706 includes ROM 2710 and RAM 2712. A basic input/output system (BIOS) can be stored in a non-volatile memory such as ROM, erasable programmable read only memory (EPROM), EEPROM, which BIOS contains the basic routines that help to transfer information between elements within the computer 2702, such as during startup. The RAM 2712 can also include a high-speed RAM such as static RAM for caching data.

The computer 2702 further includes an internal hard disk drive (HDD) 2714 (e.g., EIDE, SATA), one or more external storage devices 2716 (e.g., a magnetic floppy disk drive (FDD) 2716, a memory stick or flash drive reader, a memory card reader, etc.) and an optical disk drive 2720 (e.g., which can read or write from a CD-ROM disc, a DVD, a BD, etc.). While the internal HDD 2714 is illustrated as located within the computer 2702, the internal HDD 2714 can also be configured for external use in a suitable chassis (not shown). Additionally, while not shown in environment 2700, a solid state drive (SSD) could be used in addition to, or in place of, an HDD 2714. The HDD 2714, external storage device(s) 2716 and optical disk drive 2720 can be connected to the system bus 2708 by an HDD interface 2724, an external storage interface 2726 and an optical drive interface 2728, respectively. The interface 2724 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 2702, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 2712, including an operating system 2730, one or more application programs 2732, other program modules 2734 and program data 2736. All or portions of the operating system, applications, modules, and/or data can also be cached in the RAM 2712. The systems and methods described herein can be implemented utilizing various commercially available operating systems or combinations of operating systems.

Computer 2702 can optionally comprise emulation technologies. For example, a hypervisor (not shown) or other intermediary can emulate a hardware environment for operating system 2730, and the emulated hardware can optionally be different from the hardware illustrated in FIG. 27. In such an embodiment, operating system 2730 can comprise one virtual machine (VM) of multiple VMs hosted at computer 2702. Furthermore, operating system 2730 can provide runtime environments, such as the Java runtime environment or the .NET framework, for application programs 2732. Runtime environments are consistent execution environments that allow application programs 2732 to run on any operating system that includes the runtime environment. Similarly, operating system 2730 can support containers, and application programs 2732 can be in the form of containers, which are lightweight, standalone, executable packages of software that include, e.g., code, runtime, system tools, system libraries and settings for an application.

Further, computer 2702 can be enable with a security module, such as a trusted processing module (TPM). For instance with a TPM, boot components hash next in time boot components, and wait for a match of results to secured values, before loading a next boot component. This process can take place at any layer in the code execution stack of computer 2702, e.g., applied at the application execution level or at the operating system (OS) kernel level, thereby enabling security at any level of code execution.

A user can enter commands and information into the computer 2702 through one or more wired/wireless input devices, e.g., a keyboard 2738, a touch screen 2740, and a pointing device, such as a mouse 2742. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 2704 through an input device interface 2744 that can be coupled to the system bus 2708, but can be connected by other interfaces, such as a parallel port, an IEEE 1394 serial port, a game port, a USB port, an IR interface, a BLUETOOTH® interface, etc.

A monitor 2744 or other type of display device can be also connected to the system bus 2708 via an interface, such as a video adapter 2746. In addition to the monitor 2744, a computer typically includes other peripheral output devices (not shown), such as speakers, printers, etc.

The computer 2702 can operate in a networked environment using logical connections via wired and/or wireless communications to one or more remote computers, such as a remote computer(s) 2748. The remote computer(s) 2748 can be a workstation, a server computer, a router, a personal computer, portable computer, microprocessor-based entertainment appliance, a peer device or other common network node, and typically includes many or all of the elements described relative to the computer 2702, although, for purposes of brevity, only a memory/storage device 2750 is illustrated. The logical connections depicted include wired/wireless connectivity to a local area network (LAN) 2752 and/or larger networks, e.g., a wide area network (WAN) 2754. Such LAN and WAN networking environments are commonplace in offices and companies, and facilitate enterprise-wide computer networks, such as intranets, all of which can connect to a global communications network, e.g., the Internet.

When used in a LAN networking environment, the computer 2702 can be connected to the local network 2752 through a wired and/or wireless communication network interface or adapter 2756. The adapter 2756 can facilitate wired or wireless communication to the LAN 2752, which can also include a wireless access point (AP) disposed thereon for communicating with the adapter 2756 in a wireless mode.

When used in a WAN networking environment, the computer 2702 can include a modem 2758 or can be connected to a communications server on the WAN 2754 via other means for establishing communications over the WAN 2754, such as by way of the Internet. The modem 2758, which can be internal or external and a wired or wireless device, can be connected to the system bus 2708 via the input device interface 2722. In a networked environment, program modules depicted relative to the computer 2702 or portions thereof, can be stored in the remote memory/storage device 2750. It will be appreciated that the network connections shown are example and other means of establishing a communications link between the computers can be used.

When used in either a LAN or WAN networking environment, the computer 2702 can access cloud storage systems or other network-based storage systems in addition to, or in place of, external storage devices 2716 as described above. Generally, a connection between the computer 2702 and a cloud storage system can be established over a LAN 2752 or WAN 2754 e.g., by the adapter 2756 or modem 2758, respectively. Upon connecting the computer 2702 to an associated cloud storage system, the external storage interface 2726 can, with the aid of the adapter 2756 and/or modem 2758, manage storage provided by the cloud storage system as it would other types of external storage. For instance, the external storage interface 2726 can be configured to provide access to cloud storage sources as if those sources were physically connected to the computer 2702.

The computer 2702 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

FIG. 28 is a schematic block diagram of a sample computing environment 2800 with which the disclosed subject matter can interact. The sample computing environment 2800 includes one or more client(s) 2802. The client(s) 2802 can be hardware and/or software (e.g., threads, processes, computing devices). The sample computing environment 2800 also includes one or more server(s) 2804. The server(s) 2804 can also be hardware and/or software (e.g., threads, processes, computing devices). The servers 2804 can house threads to perform transformations by employing one or more embodiments as described herein, for example. One possible communication between a client 2802 and servers 2804 can be in the form of a data packet adapted to be transmitted between two or more computer processes. The sample computing environment 2800 includes a communication framework 2806 that can be employed to facilitate communications between the client(s) 2802 and the server(s) 2804. The client(s) 2802 are operably connected to one or more client data store(s) 2808 that can be employed to store information local to the client(s) 2802. Similarly, the server(s) 2804 are operably connected to one or more server data store(s) 2810 that can be employed to store information local to the servers 2804.

What has been described above includes examples of the subject innovation. It is, of course, not possible to describe every conceivable combination of components or methodologies for purposes of describing the disclosed subject matter, but one of ordinary skill in the art may recognize that many further combinations and permutations of the subject innovation are possible. Accordingly, the disclosed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the disclosed subject matter. In this regard, it will also be recognized that the disclosed subject matter includes a system as well as a computer-readable medium having computer-executable instructions for performing the acts and/or events of the various methods of the disclosed subject matter.

In addition, while a particular feature of the disclosed subject matter may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

In this application, the word “exemplary” is used to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Various aspects or features described herein may be implemented as a method, apparatus, or article of manufacture using standard programming and/or engineering techniques. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks [e.g., compact disk (CD), digital versatile disk (DVD) . . . ], smart cards, and flash memory devices (e.g., card, stick, key drive . . . ).

What is claimed is:

1. A system, comprising:
a memory that stores executable components; and
a processor, operatively coupled to the memory, that executes the executable components, the executable components comprising:
a user interface component configured to render an integrated development environment (IDE) interface and to receive, via interaction with the IDE interface, design input that defines aspects of an industrial automation control project; and
a project generation component configured to generate system project data based on the design input, the system project data comprising at least one of an executable industrial control program or device configuration data,
wherein the user interface component configured to:
render a device selection interface that displays a list of available device definitions and that is configured to receive, as part of the design input, selection input that selects multiple device definitions of the available device definitions; and
render a device configuration interface that displays, on a common interface, a list of the multiple device definitions and device configuration controls for the multiple device definitions, and that is configured to receive, as part of the design input via interaction with the device configuration controls, device configuration input that sets values of device configuration parameters for the multiple device definitions, and
the project generation component is configured to, in response to selection of a control, add the multiple device definitions and the values of the device configuration parameters to the industrial control project based on the selection input and the device configuration input.

2. The system of claim 1, wherein the user interface is configured to render the device selection interface in response to either of a first interaction with the IDE interface indicating that the multiple device definitions are to be assigned as child devices of a selected parent device or a second interaction with the IDE interface indicating that the multiple device interfaces are not to be unassigned to a parent device.

3. The system of claim 2, wherein the first interaction is an interaction with a device icon representing the selected parent device.

4. The system of claim 3, wherein, in response to the first interaction, the user interface component displays, on the device selection interface, a filtered lists of available device definitions corresponding to devices that are compatible with the selected parent device.

5. The system of claim 3, wherein the device selection window renders a first control that causes the list of available device definitions to comprise only device definitions that have been added to the industrial control project and have not been assigned to a parent device and a second control that causes the list of available device definitions to comprise eligible device definitions defined in a device catalog.

6. The system of claim 1, wherein
the multiple device definitions represent industrial devices of an industrial automation system to be monitored and controlled using the industrial automation control project, and
the industrial devices comprise at least one of an industrial controller, an I/O module, a network bridge device, or a motor drive.

7. The system of claim 1, wherein the device configuration parameters comprise at least one of a device name, a network address, an identifier of a slot of an industrial controller, a controller chassis size, an input filter time, a type of input signal or output signal, or a range of an input signal or an output signal.

8. The system of claim 1, wherein
the device selection interface comprises, for a device definition of the multiple device definitions, input fields configured to receive an indication of a number of instances of the device definition to be added to the industrial automation control project, and
the project generation component is configured to, in response to selection of the control, add the number of instances of the device definition to the industrial automation control project.

9. The system of claim 1, wherein the project generation component is configured to generate the system project data based on the multiple device definitions and the values of the device configuration parameters.

10. A method, comprising:
rendering, by a system comprising a processor, an integrated development environment (IDE) interface on a client device;
receiving, by the system via interaction with the IDE interface, design input that defines aspects of an industrial automation control project, wherein the receiving comprises:
rendering, in response to an interaction with the IDE interface, a device selection interface that displays a list of available device definitions;
receiving, as part of the design input, selection input that selects multiple device definitions of the available device definitions;
rendering a device configuration interface that displays, on a common interface, a list of the multiple device definitions and device configuration controls for the multiple device definitions; and
receiving, as part of the design input via interaction with the device configuration controls, device configuration input that sets values of device configuration parameters for the multiple device definitions;
in response to selection of a control, adding, by the system, the multiple device definitions and the values of the device configuration parameters to the industrial control project based on the selection input and the device configuration input; and
generating, by the system, system project data based on the design input, the system project data comprising at least one of an executable industrial control program or device configuration data.

11. The method of claim 10, wherein the rendering of the device selection interface comprises rendering the device selection interface in response to either of a first interaction with the IDE interface indicating that the multiple device definitions are to be assigned as child devices of a selected parent device or a second interaction with the IDE interface indicating that the multiple device interfaces are not to be unassigned to a parent device.

12. The method of claim 11, wherein the first interaction is an interaction with a device icon representing the selected parent device.

13. The method of claim 12, wherein the rendering of the device selection interface further comprises, in response to the first interaction, displaying, on the device selection interface, a filtered lists of available device definitions corresponding to devices that are compatible with the selected parent device.

14. The method of claim 12, wherein the device selection window renders a first control that causes the list of available device definitions to comprise only device definitions that have been added to the industrial control project and have not been assigned to a parent device and a second control that causes the list of available device definitions to comprise eligible device definitions defined in a device catalog.

15. The method of claim 10, wherein
the multiple device definitions represent industrial devices of an industrial automation system to be monitored and controlled using the industrial automation control project, and
the industrial devices comprise at least one of an industrial controller, an I/O module, a network bridge device, or a motor drive.

16. The method of claim 10, wherein the device configuration parameters comprise at least one of a device name, a network address, an identifier of a slot of an industrial controller, a controller chassis size, an input filter time, a type of input signal or output signal, or a range of an input signal or an output signal.

17. The method of claim 10, wherein
the device selection interface comprises, for a device definition of the multiple device definitions, input fields configured to receive an indication of a number of instances of the device definition to be added to the industrial automation control project, and
the adding of the multiple device definitions comprises adding the number of instances of the device definition to the industrial automation control project.

18. The method of claim 11, wherein the generating comprises generating the system project data based on the multiple device definitions and the values of the device configuration parameters.

19. A non-transitory computer-readable medium having stored thereon instructions that, in response to execution, cause an industrial integrated development environment (IDE) system comprising a processor to perform operations, the operations comprising:
rendering an integrated development environment (IDE) interface on a client device;
receiving, via interaction with the IDE interface, design input that defines aspects of an industrial automation control project, wherein the receiving comprises:
rendering, in response to an interaction with the IDE interface, a device selection interface that displays a list of available device definitions;
receiving, as part of the design input, selection input that selects multiple device definitions of the available device definitions;
rendering a device configuration interface that displays, on a common interface, a list of the multiple device definitions and device configuration controls for the multiple device definitions; and
receiving, as part of the design input via interaction with the device configuration controls, device configuration input that sets values of device configuration parameters for the multiple device definitions;
in response to selection of a control, adding the multiple device definitions and the values of the device configuration parameters to the industrial control project based on the selection input and the device configuration input; and
generating system project data based on the design input, the system project data comprising at least one of an executable industrial control program or device configuration data.

20. The non-transitory computer-readable medium of claim 19, wherein the rendering of the device selection interface comprises rendering the device selection interface in response to either of a first interaction with the IDE interface indicating that the multiple device definitions are to be assigned as child devices of a selected parent device or a second interaction with the IDE interface indicating that the multiple device interfaces are not to be unassigned to a parent device.
